(19) United States
(12) Patent Application Publication
(10) Pub. No.: US 2025/0299523 A1
(43) Pub. Date: Sep. 25, 2025

(54) SYSTEMS AND METHODS FOR ENHANCED SECURITY AND SAFETY MANAGEMENT USING COMPUTER VISION

(71) Applicant: Schlage Lock Company LLC, Carmel, IN (US)

(72) Inventors: Robert Prostko, Carmel, IN (US); Andrew Jay Lasley, Noblesville, IN (US); Ryan C. Kincaid, Indianapolis, IN (US); Robert C. Martens, Carmel, IN (US); Ryan Charles Roberts, Dallas, TX (US); Brad D. Aiken, Carmel, IN (US); Spyros Zafeiropoulos, Carmel, IN (US); Ken P. Cook, Carmel, IN (US); Devin A. Love, Westfield, IN (US); Jennifer Sieber, Brookline, MA (US)

(21) Appl. No.: 19/082,978

(22) Filed: Mar. 18, 2025

Related U.S. Application Data
(60) Provisional application No. 63/567,247, filed on Mar. 19, 2024.

(51) Int. Cl. G07C 9/30; G06V 40/10; G07C 9/20

(52) U.S. Cl. CPC G07C 9/30; G06V 40/103; G07C 9/20

(57) ABSTRACT

Systems and methods are provided for a security and safety management system. The system utilizes a computer vision system and machine learnable algorithms, including models, to identify from information captured by one or more visions sensors, including cameras, a plurality of security related challenges. A recognition module or circuity can detect, including, for example, via image recognition, at least information pertaining to: unauthorized access to entry/exit points; a derived behavioral analysis of at least identified potential intruders; provide information that can enhance emergency responses; assist in compliance with regulatory standards; and, be utilized in connection with predictive maintenance of security hardware. By leveraging advanced algorithms, machine learning, and integration with security hardware, the systems and methods disclosed herein can represent a significant advancement in the field of security technology, offering a robust solution for enhancing safety and operational efficiency in a wide range of environments.

### CROSS-REFERENCE TO RELATED APPLICATIONS

The present application claims priority to of U.S. Provisional Patent Application No. 63/567,247, filed on Mar. 19, 2024, the contents of which is hereby incorporated by reference in its entirety.

### TECHNICAL FIELD

The present disclosure generally relates to security and safety management systems, and, more particularly, to security and safety management systems that utilize a computer vision system for monitoring, recognition, and/or responding to a variety of different types of existing, predicted, and/or potential safety concerns in various environments at which one or more persons are, or may be, present.

### BACKGROUND

Current security and safety systems often rely on manual monitoring or simplified automated processes that may not adequately address complex situations like tailgating, threat detection, emergency lockdowns, or maintenance needs. Further, such manual monitoring or simplified automated processes are often reactionary in nature, thereby effectively generally being limited to being a temporary deterrence to the performance of illicit acts by certain individuals.

### SUMMARY

The present disclosure may comprise one or more of the following features and combinations thereof.

Embodiments of the present disclosure provide systems and methods for security and safety management using computer vision technology. The embodiments disclosed herein, either in individually or in various combinations, can address a plurality of challenges, from detecting unauthorized access and enhancing emergency responses to ensuring compliance with regulatory standards and performing predictive maintenance. By leveraging advanced algorithms, machine learning, and integration with security hardware, the systems and methods disclosed herein represent a significant advancement in the field of security technology, offering a robust solution for enhancing safety and operational efficiency in a wide range of environments.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a simplified block diagram representation of at least a portion of a security management system.

FIG. 2 illustrates a plan view of an exemplary lockset installed to a passageway device.

FIG. 3 illustrates a simplified representation of an exemplary floor layout for a building having a plurality of vision sensors and auxiliary devices.

FIG. 4 illustrates an exemplary method for tailgating/piggybacking detection by the illustrated security management system.

FIG. 5 illustrates an exemplary method for safety or threat detection, including authorized assisted entry and response, including remote guarding, by the illustrated security management system.

FIG. 6 illustrates an exemplary method for emergency lockdown and wayfinding by the illustrated security management system.

FIG. 7 illustrates an exemplary method for preventive maintenance and broken door detection, as well as detection of compliance with regulations, by the illustrated security management system.

FIG. 8 illustrates an exemplary method for detection of individual intent and an associated response by the illustrated security management system.

FIG. 9 illustrates an exemplary method for detection of a lock state or passageway device position by the illustrated security management system.

### DETAILED DESCRIPTION OF THE ILLUSTRATIVE EMBODIMENTS

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

In the Detailed Description herein, references to “one embodiment,” an “embodiment,” and “example embodiment,” etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The present disclosure relates to a comprehensive security and safety management system that can integrate advanced computer vision (CV) technology to address various security challenges and operational inefficiencies. Moreover, the systems and methods discussed herein can provide a comprehensive security and safety management system that can utilize machine based recognition of features provided by, including identified from, captured information, including images, obtained by a computer vision system to detect, analyze, and respond to various situations, including situations involving existing, predicted, and/or potential security issues/threats and/or maintenance/regulation issues. The system can further determine, based on the identified issue, the appropriate personnel to contact, as well as provide real-time, or near-real-time, situation updates to that personnel. As discussed below, features provided by the security management system can include, but are not limited to, tailgating detection, behavior analysis for safety improvements, threat isolation and response, dynamic security zone management, unauthorized entry detection, emergency lockdown, wayfinding during emergencies, predictive maintenance for security hardware, intent determination, compliance with safety regulations, and/or door status monitoring, as well as various combinations thereof, among other features.

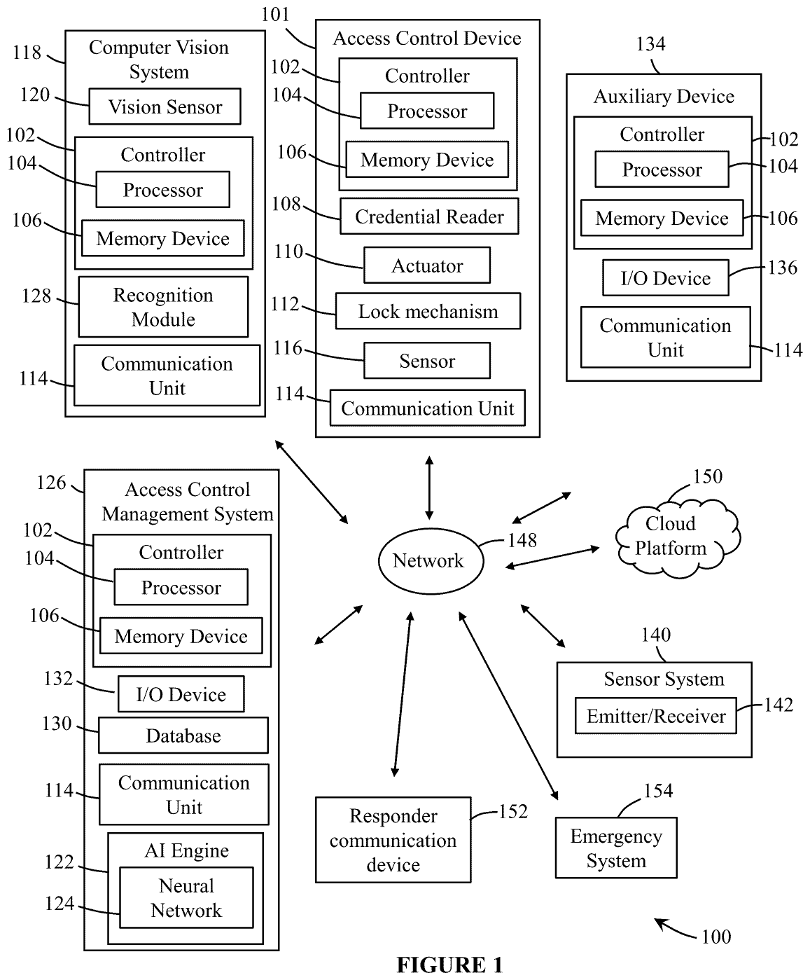

FIG. 1 illustrates a simplified block diagram representation of at least a portion of a security management system 100. According to certain embodiments, the security management system 100 includes one or more of an access control device(s) 101, computer vision system(s) 118, access control management system(s) 126, auxiliary device(s) 134, sensor system(s) 140, cloud platform(s), responder communication device(s) 152, and/or emergency response system(s) 154, as well as various combinations thereof, among other features. Further, while certain embodiments may be described herein, the access control device(s) 101, computer vision system(s) 118, access control management system(s) 126, auxiliary device(s) 134, sensor system(s) 140, cloud platform(s) 150, responder communication device(s) 152, and/or emergency response system(s) 154 can be embodied as any type of device, collection of devices, or systems suitable for performing the functions described herein.

As discussed herein, according to certain embodiments, at least certain components of the security management system 100 can be selectively actuated in response to automated recognition, including, for example, via use of artificial intelligence, of certain features or criteria from information, including images, captured by the computer vision system 118. Such automated recognition, which can, for example, be provided in real-time, or near real-time, can include, for example, identification of tailgating or piggybacking through an opened passageway, and/or a safety or threat detection, including safety or thread detection based on a determination of an intent of one or more individuals that is at least partially based on image recognition relating to body posture, body positioning/location, and/or associated body movement, among other criteria. The system 100 can further utilize at least automated recognition to coordinate responses to such identified detected issues, including, for example, isolating the identified safety/threat issue(s), including via emergency lockdown. As also discussed below, the system 100 can further be configured to assist in wayfinding, such as, for example, assisting in evacuation or other protective/crowd control measures, and/or guidance of responders or emergency personnel.

Additionally, or alternatively, as also discussed below, at least portions of the security management system 100 can be selectively actuated in response to automated recognition, including, for example, via the application of artificial intelligence to information captured by the computer vision system 118, of a current and/or predicted status of certain components of the security management system 100. Such status determinations can include, for example, identifying a potential security risk based on a locked/unlock status of a lockset of the access control device 101, and/or an opened/closed position of an associated passageway device, including, for example, a door or gate, among others. Such current or predicted status determinations can also, for example, indicate a maintenance issue and/or non-compliance with regulations/guidelines to which, in response, the security management system 100 can further determine, and communicate, a corresponding remedial action for personnel to undertake.

Further, in response to at least the issues identified above, the security management system 100 can further be configured to automatically identify, as well a communicate, a notification of the identified issue(s) to the appropriate personnel. For instance, the security management system 100 can utilize one or more machine learning models to assist in determining whether the issue(s) identified by via machine based recognition from at least information captured by the camera vision system 118 is to be communicated to internal personnel, including, for example to employees of an associated location/building, or to an emergency system 154, including, for example, to a 911 call center. Additionally, the security management system 100 can be configured to continuously use image recognition to provide real time updates of such issues, and thus can provide updated communication(s) relating to such issues. Such communication(s) can occur, for example, via selective operation of one or more auxiliary devices 124 and/or by communications to one or more responder communication devices 152, including, for example, two-way radios, smart phones, and/or laptops, among other mobile and/or non-mobile communication or computing devices, among others.

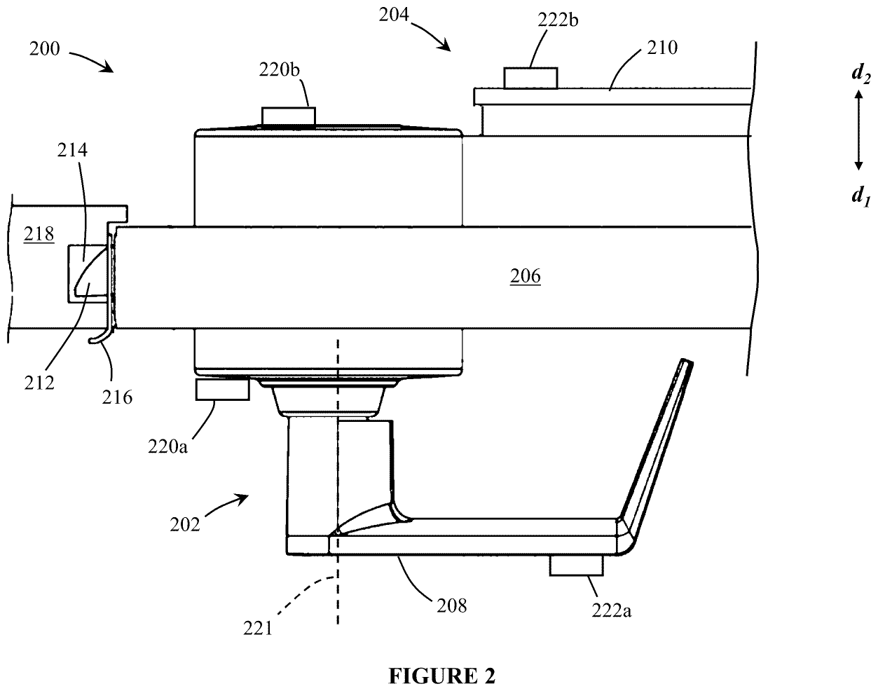

According to the illustrated embodiment, the access control device 101 can include a lockset 200 (FIG. 2) that is coupled to a passageway device, such as, for example, a door 206. In the illustrated embodiment, the lockset 200 can include a trim portion 202 on the first side of the door 206, and an exit device 204 (e.g., panic bar, rim exit device, a pushbar or push pad exit device) on an opposing side of the door 206. The lockset 200 and/or access control device 101 can further include a lock mechanism 112 configured to control access through the passageway associated with the passageway device. For example, as seen in FIG. 2, the lock mechanism 112 can include a deadbolt or latch bolt (generally referred to as bolt 212), among other components typical of a lock device or lockset 200, that can be at an extended position such the bolt 212 can extend through a strike plate 216 and into a strike plate hole or mortise 214 in a door jamb 218. Additionally, at the extended position, the lock mechanism 112 can be in a locked state that prevents the bolt 212 from being displaced from the extended position to a retracted position, and, moreover, prevents the bolt 212 from being withdrawn from strike plate hole or mortise 214 so as to at least attempt to retain the door 206 at the closed position. Conversely, when the lock mechanism 112 is in an unlocked state, the bolt 212 may be displaced to the retracted position at which the bolt 212 is not in the strike plate hole or mortise 214 in the door jamb 218, thereby allowing the door 206 to be displaced to an open position that accommodates passage through the passageway. According to the illustrated embodiment, when the lock mechanism 112 is in the unlocked state, the bolt 212 can be displaced to the retracted position via rotation of a lever 208 of the trim portion 202 away from a first home position about a central axis 221. Similarly, when the lock mechanism 112 is in the unlocked state, the bolt 212 can be displaced to the retracted position via a depression or displacement of the push bar 210 from a second home position in a first, generally inward direction (generally indicated by direction “d₁” in FIG. 2) toward the door 206. Additionally, or alternatively, the lockset 200 can be an electronic lock having an actuator 110 (FIG. 1), including, for example, a motor, that can be activated to displace the bolt 212 to either the extended position or retracted position and/or to facilitate the lock mechanism 112 being in the locked state or the unlocked state.

Depending on the particular embodiment, the access control device 101 can include a credential reader device 108 that is configured to communicate with credential devices, including, but not limited to a smartcard, proximity card, key fob, token device, and/or mobile device, among others. Moreover, the credential reader device 108 can be embodied as any type of device capable of reading credentials. The credentials received, and/or processed by, the credential reader device 108 may vary depending on the particular embodiment.

According to certain embodiments, the access control device 101 can also include at least one sensor 116 configured to monitor movement and/or position of the lockset 200, credential reader device 108, and/or door 206. According to certain embodiments, the sensor 116 can comprise one or more proximity sensors, optical sensors, light sensors, electromagnetic sensors, hall effect sensors, audio sensors, temperature sensors, motion sensor, piezoelectric sensors, cameras, switches (e.g., reed switches, physical switches, etc.), inductive sensors, capacitive sensors, and/or other types of sensors. In some embodiments, the sensor 116 is an inertial sensor that can be embodied as, or include, an accelerometer and/or gyroscope. Information provided by the sensor 116 can be utilized to determine movement and/or position of the lockset 200, credential reader device 108, and/or door 206. Additionally, according to certain embodiments, information provided by the at least one sensor 116 can indicate, or be used to determine, the locked/unlocked state of the lock mechanism 112 and/or the extended/retracted position of the bolt 212.

Additionally, or alternatively, one or more mechanical markers 220a, 220b can be positioned about the lockset 200. According to such an embodiment, the mechanical markers can have different indicia, colors, or shapes, among other visually distinct identifiers for at least one of the locked state or the unlocked state, and/or one of the bolt 212 being at the extended position or retracted position. Moreover, according to certain embodiments, the mechanical marker 220a, 220b may be visible to at least the camera vision system 118 when the lock mechanism 112 is in either the locked state or the unlocked state, and/or the bolt 212 is in one of the extended position or retracted position. Alternatively, the mechanical markers 220a, 220b can have different visual representations that are viewable for when the lock mechanism 112 is in either the locked state or the unlocked state, and/or the bolt 212 is in either the extended position or retracted position.

Additionally, or alternatively, the sensor system 140 can include one or more emitter/receiver type sensors 142, that includes an emitter 222a, 222b positioned on the lockset 220 and an associated receiver at another location. The types of senor utilized by the emitter/receiver type sensors 142 can include, for example, an infrared (IR) sensor wherein the emitter 222a, 222b emits an infrared signal that can include various types of information, including, for example, information indicating the locked/unlocked state of the lock mechanism 112, and/or the extended/retracted position of the bolt 212, as discussed below.

One or more of the access control device(s) 101, computer vision system(s) 118, access control management system(s) 126, and/or auxiliary device(s) 134, among other components of the security management system 100 can include one or more controllers 102 having at least one processor 104 and at least one memory device 106. The controller 102, processor(s) 104, and/or memory device(s) 106 may, or may not, be dedicated to the operation of the security management system 100. The processor 104 can comprise one or more processors, including compute circuits, that can be utilized to control operation of the associated component of the security management system 100, and, optionally, can also be utilized in connection with controlling one or more other operations or components of the security management system 100. Therefore, according to certain embodiments, one controller 102, including one or more processors 104 of that controller 102, can be utilized to control operation of at least the access control device 101, or the corresponding components, portions, or segments of the access control device 101. Alternatively, a plurality of controllers 102, or combinations of processors 104, including compute circuits, can be utilized to control operation of the access control device 101, as well as control operations of different components or systems of the system 100, including the access control management system 126. Thus, for example, while certain embodiments herein may mention functions being performed by a controller 102, including the associated processor 104, such functions can be performed by a single controller or processor, or, alternatively, one or more functions can be performed by one or more controllers or processors, and one or more other functions can be performed by one or more other controllers or processors or combinations of controllers or processors.

The memory device 106 can have instructions stored therein that are executable by the processor 104 to cause the processor 104 to perform a corresponding action. The processor 104 can be embodied as, or otherwise include any type of processor, controller, or other compute circuit capable of performing various tasks of at least the associated component of the system 100. For example, the processor 104 can be embodied as a single or multi-core processor(s), a microcontroller, or other processor or processing/controlling circuit. In some embodiments, the processor 104 can be embodied as, include, or otherwise be coupled to an FPGA, an application specific integrated circuit (ASIC), reconfigurable hardware or hardware circuitry, or other specialized hardware to facilitate performance of the functions described herein. Additionally, in some embodiments, the processor 104 can be embodied as, or otherwise include a high-power processor, an accelerator co-processor, or a storage controller.

The memory device 106 can be embodied as any type of volatile (e.g., dynamic random-access memory (DRAM), etc.) or non-volatile memory capable of storing data therein. Volatile memory may be embodied as a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

In some embodiments, the memory device 106 can be embodied as a block addressable memory, such as those based on NAND or NOR technologies. The memory device 106 can also include future generation nonvolatile devices, such as a three-dimensional crosspoint memory device (e.g., Intel 3D XPoint™ memory), or other byte addressable write-in-place nonvolatile memory devices. In some embodiments, the memory device 106 can be embodied as, or may otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device 106 can refer to the die itself and/or to a packaged memory product. In some embodiments, 3D crosspoint memory (e.g., Intel 3D XPoint™ memory) can comprise a transistor-less stackable cross point architecture in which memory cells sit at the intersection of word lines and bit lines and are individually addressable and in which bit storage is based on a change in bulk resistance.

One or more of the access control device(s) 101, computer vision system(s) 118, access control management system(s) 126, and/or auxiliary device(s) 134, among other components of the security management system 100 can include a communication unit 114 that can accommodate the communication of information to/from each other, as well as other components of the security management system 100. The communication unit 114 can be configured for either, or both, wired or wireless communications, including, for example, via proprietary and non-proprietary wireless communication protocols. For example, the communication unit 114 can be configured to accommodate Wi-Fi, ZigBee, Bluetooth, radio, cellular, or near-field communications, among other communications that use other communication protocols, including, but not limited to, communications over a wireless network 148, such as, for example internet, cellular, or Wi-Fi networks, as well as combinations thereof. According to certain embodiments, the communication unit 114 can comprise a transceiver.

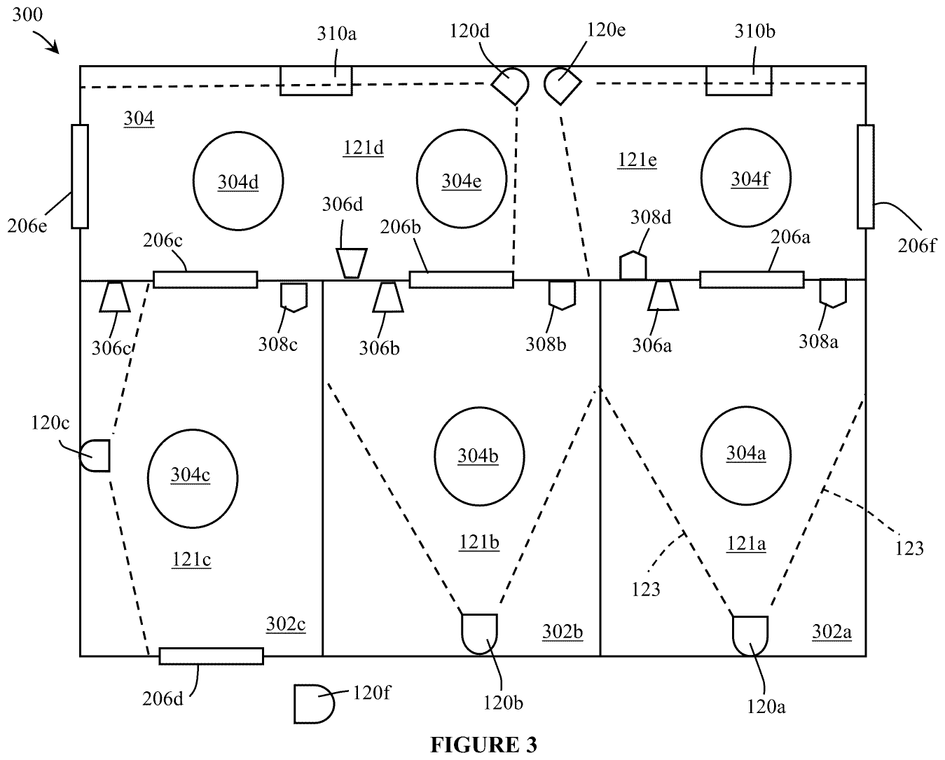

While the computer vision system 118 is illustrated in FIG. 1 as being apart from other components of the security management system 100, according to certain embodiments at least a portion of the computer vision system 118 may be part of, including shared with, other components of the security management system 100, including, for example, the access control management system 126 and/or the access control device 101, among others. The computer vision system 118 can include one or more vision sensors 120, including, but not limited to, optical sensors such as, for example, two-dimensional cameras, stereo depth cameras, stereo sensors, RGBD (red, green, blue, depth) cameras, three-dimensional sensors, and three-dimensional cameras, as well as combinations thereof, among other types of vision sensors. For example, the vision sensors 120a-f shown in FIG. 3 can be cameras that can capture one or more images or video, which can be generally referred to herein as captured information.

The computer vision system 118 can also include a machine learning recognition module 128 that can derive information from the captured information obtained from the vision sensor 120 that can be used to adjust one or more control settings of at least the access control device 101 and/or the auxiliary device 134. For example, as discussed below, the recognition module 128 can generate information from the captured information that identifies tailgating or piggybacking through an opened passageway, safety or threat detection, and/or an intent of one or more individuals that is at least partially based on image recognition relating to body posture, body positioning/location, and/or associated body movement, among other criteria. Additionally, or alternatively, the recognition module 128 can generate information that identifies the locations of one or more individuals, as well as characteristics of those individual, including, for example, whether the individual is a child or an adult. Additionally, or alternatively, the recognition module 128 can, for example, generate information that identifies position/state information regarding at least the lockset 200, as well as actual, developing, or potential maintenance issues with respect to at leas the lockset, among other devices.

Such recognition features of the recognition module 128 can be derived, and updated, based on one or more models, including algorithms, and/or input information that can include information provided by, or derived from, a databased 130 containing related historical reference information and/or from a feedback module, among other input information. According to certain embodiments, such machine learning for either or both the development and refinement of the model(s), including algorithms, can utilize training of a neural network 124 of an artificial intelligence (AI) engine 122. Further, the feedback module, which can be located at either or both the computer vision system 118 or the security management system 100, among other locations that may, or may not, be part of the security management system 100, can include a recording of adjustments made by a user of the system 100, as may be communicated for example, via an input/output (I/O) device 132, including, but not limited to, a keyboard, keypad, touch screen, monitor, display, mouse, button, or joystick, among others, as further discussed below. The feedback module can include, among other information, information indicating the extent of the adjustment(s) or resulting setting(s) from such adjustment(s), among other information, that can be manually inputted to the system 100.

The auxiliary device 134 can be configured to communicate with one or more individuals in a variety of different manners, including, for example, via visual and/or audible communications. For example, referencing FIG. 3, the auxiliary device 134 can include one or more of a light 304a-f, speaker 306a-d, sign 310a, 310b, and/or sound sensor 308a-d, including, for example, a microphone. While FIG. 3 illustrates each type of auxiliary device 134, 304a-f, 306a-d, 310a-b, 308a-d, as a separate device, according to certain embodiments, one or more of the auxiliary devices 134 can be part of the same device. For example, the speaker 306a-d and sound sensor 308a-d can be part of a two-way radio, among other types of devices. The light 304a-f can be configured for selective operation in response to at least information derived by the recognition module 128, including illumination, as well as selective illumination levels, colors, and/or patterns. The sign 310a, 310b can be operated such that selective portions of the sign are illuminated to convey a selected information, including a message(s). Additionally, or alternatively, the information displayed by the sign 310a, 310b can change or be adjusted in response to different situations or circumstances, as identified by at least the system 100 using information derived by the recognition module 128. As also seen in FIG. 1, according to certain embodiments, the auxiliary device 134 can include an input/output (I/O) device 136 that can be similar to the above-discussed I/O device 132 of the access control management system 126.

FIG. 3 illustrates a simplified representation of an exemplary floor layout 300 for a building having a plurality of vision sensors 120a-f and auxiliary devices 304a-f, 306a-d, 310a, 310b, 308a-d. In this particular example, the floor layout 300 includes a first room 302a, a second room 302b, and a third room 302c, as well as an adjoining hallway 304, each of which has at least one of the above-discussed auxiliary devices 304a-f, 306a-d, 310a, 310b, 308a-d. Additionally, passage to/from each room 202a-c and hallway 204 can be at least partially controlled by the position of an associated passageway device 206 (e.g., door 206a-f) and an access control device 101 and/or an associated lockset 200 that is coupled to each door 206a-f. Thus, for example, passage from the hallway 304 to the first room 302a, and vice versa, can be controlled via the door 206a being in a closed position and the lock mechanism 112 of the access control device 101 that is coupled to the door 206a being in the locked state with the corresponding bolt 212 being at the extended position. Additionally, the presence of an individual positioned within the first room 302a can be detected by the associated vision sensor 120a (e.g., camera) capturing one or more images of that individual when the individual is within the field of view 121a (as generally indicated by the area within associated boundaries 123) of the vision sensor 120a. Thus, as seen in FIG. 3, each vision sensor 120a-f can, according to certain embodiments, have a corresponding field of view 121a-e which may, or may not, overlap with the field of views of other vision sensors 120a-f. Further, according to certain embodiments, one or more vision sensors 102, such as camera 120 f and/or one or more auxiliary devices 134 can be located outside of the building, or in an exterior area. According to such an embodiment, the vision sensor 120 can capture information that is occurring outside of, including adjacent to, a door 206d, while the auxiliary device 134 can be utilized to communicate with those individuals outside of the building.

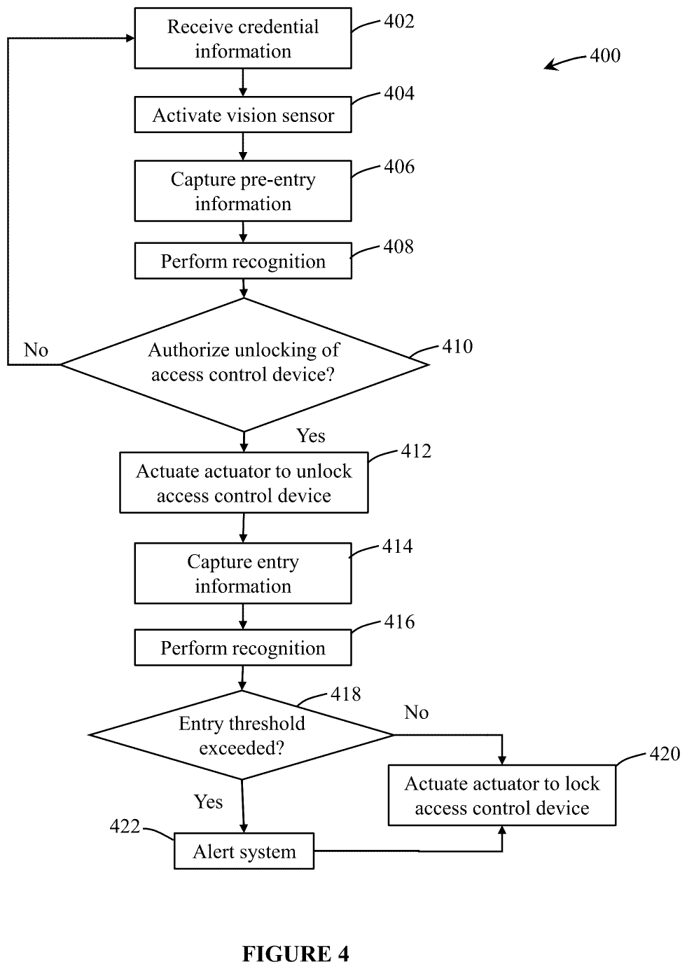

FIGS. 4-9 illustrate exemplary methods 400, 500, 600, 700, 800, 900 for using the security management system 100 for various aspects of monitoring, recognizing, and/or responding to a variety of different types of existing, predicted, and/or potential safety, operation, and/or maintenance concerns. The methods 400, 500, 600, 700, 800, 900 are described below in the context of being carried out by the illustrated exemplary security management system 100. However, it should be appreciated that the methods 400, 500, 600, 700, 800, 900 can likewise be carried out by any of the other described implementations, as well as variations thereof. Further, the methods 400, 500, 600, 700, 800, 900 correspond to, or are otherwise associated with, performance of the blocks described below in the illustrative sequences of FIGS. 4-9, respectively. It should be appreciated, however, that the methods 400, 500, 600, 700, 800, 900 can be performed in one or more sequences different from the illustrative sequences. Additionally, one or more of the blocks mentioned below may not be performed, and the methods 400, 500, 600, 700, 800, 900 can include steps or processes other than those discussed below. Further, the illustrated exemplary security management system 100 can be configured to perform any one, or any combination, of the methods 400, 500, 600, 700, 800, 900 discussed herein, among other methods or functions.

FIG. 4 illustrates an exemplary method 400 for tailgating/piggybacking detection by the illustrated security management system 100. The method 400 can utilize vision sensors 120, such as, for example, high-resolution cameras that capture information, including video feed, by one or more machine learning algorithms of the recognition module or circuity 128 in real-time or near real-time to generally continuously monitor an access point(s), including, for example, one or more entry points and/or exit points, such as, for example, a entry and exit points to/from and/or within a building, including rooms and hallways. By analyzing the video feed in real-time or near real time, the system 100, including the recognition module or circuity 128 or one or more controllers 128, can count the number of individuals passing through the entry/exit points and cross-references this number with the credentials, or number of credentials, authenticated by the access control device 101 and/or access control management system 126. Moreover, the system 100 can distinguish between individuals entering through a passageway alone versus those attempting to follow (tailgate) directly behind another without proper authentication. Such capability can be particularly important for sensitive areas where maintaining controlled access is paramount. When unauthorized access is detected, the system 100 can alert security personnel, trigger an audible alarm, and/or integrate with one or more access control device(s) 101 to temporarily lock down one or more access points (e.g., entry/exit points).

With respect to the example provided by FIG. 4, the method 400 can include activation of at least a portion of the system 100 by the occurrence, or recognition, of a trigger event. For example, at block 402, the triggering event can be a card reader device 108 being activated via at least initiation of a communicative engagement with a credential device of one or more individuals. However, a variety of other events can be utilized to trigger at least a portion of the system 100, including the computer vision system 118, such as, for example, the vision sensor 120, as generally indicated by block 404. For example, according to certain embodiments, the system 100 can include a motion sensor and/or sound sensor that can be used to indicate the presence of one or more individuals in an area associated with a particular access control device(s) 101 that can detect the presence of the one or more individuals in a manner that can trigger operation of the vision sensor 120. However, according to other embodiments, the computer vision system 118 and/or vision sensor 120 can be generally continuously operated and/or activated.

At block 406, prior to entry through a passageway associated with the credential reader device 402 that received credential information at block 402, at least the vision sensor 120 having the credential reader device 108 within the corresponding field of view 121a-e can capture information, including, one or more images, photographs, and/or video, as well as combinations thereof, of one or more individuals associated with the credential device. At block 408, using the captured information obtained at least at block 406, the recognition module 128 can analyze the captured information to at least determine the number of individuals at or around the credential reader device 108. Additionally, according to certain embodiments, the recognition module 128 can at least attempt to identify, from the captured information, other secondary factors, including, for example, an identity of the particular individual(s) providing the credential information associated with the credential device.

At block 410, one or both of the credential information received that block 402, and the information obtained from the image recognition at block 408, can be analyzed in connection with determining, such as, for example, by a controller 102, whether to authorize an unlocking of the lockset 200 of the access control device 101 associated with the credential reader device 108 receiving the credential information and/or an associated door 206a-f. Such authorization can include not only confirmation of an authenticity of provided credential information, and associated permissions, but also an evaluation of the information provided by the recognition performed at block 408. For example, according to certain embodiments, such evaluation of the information provided by the image recognition performed at block 408 can include identifying the identity of the person associated with the provided credential information, including confirming the identity corresponds to the provided credential information. Additionally, such recognition, as performed at block 408, can include identifying the number of individuals that may be present at the associated door 206a-f and/or credential reader device 108. Moreover, in certain situations, the number of individuals identified as being at, or in proximity of, the door 206a-f and/or credential reader device 108 can be determined to exceed a predetermined threshold, to which, in response, authorization to unlock the lockset 200 can be denied. In such a situation in which access is denied at block 410, the system 100 can, for example, be further configured to alert, such as, for example, via use of an auxiliary device 134, at least some of the individuals at or around the door 206a-f and/or credential reader device 108 to move away from the door 206a-f/credential reader device 108, and that the credential information be again presented at block 402. Thus, in such situations, the method 400 can return to block 402.

If at block 410 a determination is made that authorization is to be granted, then at block 412 one or more signals can be generated by a controller 102 to activate the actuator 110 in a manner that can unlock the lock mechanism 112. With the lock mechanism 112 in the unlocked state, the corresponding door 206a-f can be displaced from the closed position to an open position so as to accommodate passage through the associated passageway, which in this example, provides the entry/exit point. Additionally, or alternatively, if authorization is granted, then at block 412 one or more signals can be generated by the controller 102 to automatically displaced the corresponding door 206a-f from the closed position to an open position.

As entry through the passageway occurs, at block 414 the vision sensor(s) 120 can capture information that can be used by the recognition module or circuitry 128 at block 416 to recognize one or more occurrences of a person(s) that pass through the passageway since at least the unlocking of the lock mechanism 112. Moreover, the recognition performed at block 416 can provide, or be used to derive, a count or other manner of identifying the number of individuals that are passing, or have passed, through the passageway since at least the unlocking of the lock mechanism 112 and/or the opening of the corresponding door 206a-f.

At block 418, the count obtained at block 416 from recognition of information captured by the one or more vision sensors 120 at block 414 can be evaluated with respect to an entry threshold number to determine whether the entry threshold number has been exceeded. The entry threshold number can be based on a variety of criteria, including, for example, the number of credential devices that were authenticated by the credential reader device 108 in connection with the unlocking of the lock mechanism 112 at block 412. Thus, if for example a single credential device was authenticated for the unlocking of the lock mechanism 112 such that the entry threshold number is one, and the recognition performed at block 416 indicates only one individual passed through the passageway, then the entry threshold number is not exceeded. In such an event, at block 420, one or more signals can be generated by a controller 102 to activate the actuator 110 in a manner that can lock the lock mechanism 112. According to certain embodiments, the locking of the lock mechanism 112 can occur upon the door 206a-f being returned to a closed position, and/or upon expiration of a time duration after the lock mechanism 112 was unlocked, among other criteria.

If, however, a determination is made at block 418 that the entry threshold number is exceeded, then at block 422 the system 100 can generate an alert to notify personnel of an identified piggybacking/tailgating event. The alert may be generated and communicated by the system 100, including, for example, to the responder communication device 152, the emergency system 154, and/or via operation of one or more auxiliary devices 134. Further, the determination at block 418 that the entry threshold number is exceeded can also result in the system 100 generating one or more signals to lock the lock mechanism 112, as discussed above with respect to block 420.

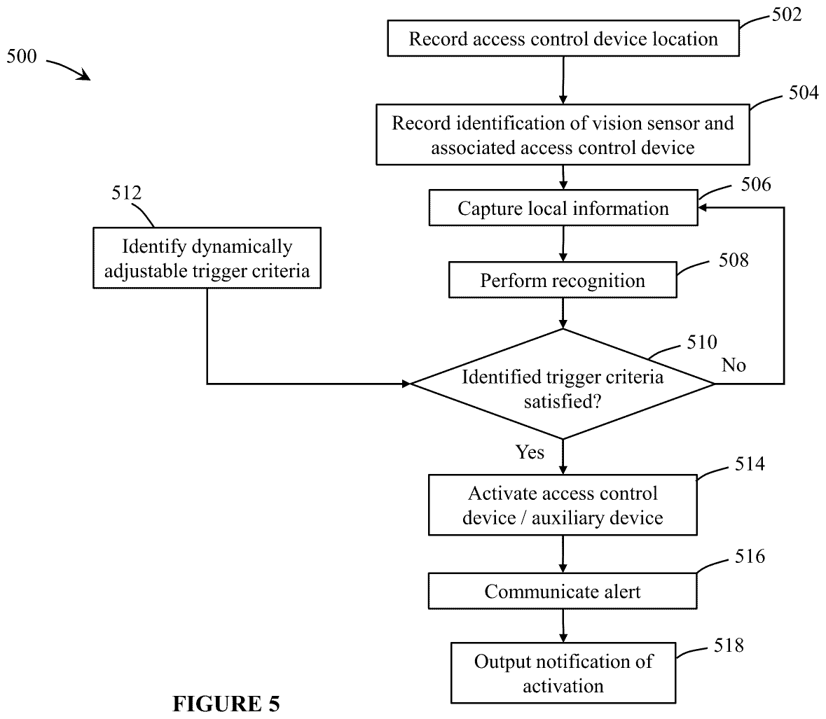

FIG. 5 illustrates an exemplary method 500 for safety or threat detection, including authorized assisted entry and response and/or remote guarding, by the illustrated security management system 100. Such a method 500 can, according to certain embodiments, employ behavior analysis in which the system 100, including, for example, the recognition module or circuitry 128, can analyze and/or identify, from information captured by one or more vision sensors 120, patterns of movement and/or behavior of one or more individuals within a space to identify potential safety threats or hazardous behaviors. The database 130 can provide a repository or collection of behavior signatures that the recognition module or circuitry 128 can utilize in recognition of actions, from the captured information, that deviate from normal or anticipated actions, including, for example, actions that may be indicative of aggressive gestures, unauthorized entry attempts, and/or unusual congregation of individuals, among other actions, which could indicate a presence of an actual, potential, or developing threat. Upon detecting such an actual or potential threat, the system 100 can pinpoint the location of the threat such that the corresponding access control device(s) 101 in that identified location(s) can be actuated, such as, for example, locked, to initiate a lockdown of a specific zone(s) in at least an attempt to isolate the threat. Such an approach can also be adaptable in allowing for dynamic adjustment of secure and unsecure zones based on situational factors, such as, for example, time-specific events or emergency protocols, among other situational factors.

Additionally, or optionally, according to certain embodiments, the method 500 can be utilized in connection with detection of unauthorized assisted entry through an access point (e.g., entry/exit point). For example, such an approach can be utilized to detect scenarios that suggest a breach or an attempt to bypass security protocols at entry/exit points. By analyzing body posture, movement patterns, and the interaction between individuals near doors 206a-f associated with entry/exit points, the recognition module or circuity 128 can identify suspicious behaviors such as, for example, loitering with the intent to assist unauthorized entry. For example, the advanced algorithms or models of the recognition module or circuity 128 can be configured to interpret body kinetics to determine if a door 206a-f has been manually forced open without a detectable key or usage of an authorized credential device. Such an approach can address a typical, or common, loophole in physical security measures.

Additionally, or optionally, according to certain embodiments, the method 500 can provide remote guarding of at least entry/exit points. For example, the method 500 can integrate two-way audio capabilities, such as, for example, via one or more auxiliary devices 134, with video analytics, as may be provided by the computer vision system 118 and/or recognition module or circuity 128, to provide remote guarding solutions. According to certain embodiments, security personnel can interact directly with individuals identified by the computer vision system 118 and/or recognition module or circuity 128 as potential threats or unauthorized entrants, offering a chance for deterrence through verbal commands or warnings via operation of one or more auxiliary devices 134, including, for example a sound sensor(s) 308a-d (e.g., microphone) and a speaker(s) 306a-d. Such capabilities can extend the reach of physical security measures, allowing for a proactive rather than reactive approach to security management.

According to the exemplary method 500 illustrated in FIG. 5, the method 500 can include recording a location(s) for one or more access control devices 101 and/or doors 206a-f at block 502. For example, a GPS location, room 302a-c, 304 level information, or predetermined zone assignments, among other location identifiers, can be stored at the database 130 for a plurality of access control devices 101 and/or doors 206a-f. Similarly, an identification of which access control device(s) 101 and/or door(s) 206a-f is associated with a particular vision sensor(s) 120 can also be recorded, including, for example, at the database 130. Moreover, a record can be made and stored as to which access control device 101 is associated with information being captured by a particular vision sensor 120 such that the system 100 can identify which particular access control device(s) 101 is associated with information being captured by a vision sensor(s) 120. Additionally, or alternatively, a location identifier can be stored by the system 100 for a plurality of vision sensors 120 and/or the associated fields of view 121a-e for a plurality of vision sensors 120. Moreover, the location information identified and/or recorded at blocks 502 and 504 can be utilized to identify a location corresponding to the information being captured by the vision sensor(s) 120.

At block 506, the one or more of the vision sensors 120 can be operated, such as, for example, at a room level 302a-c, 304, so as to capture information that is to be analyzed by the recognition module or circuitry 128 at block 508. As previously discussed, according to certain embodiments, such an analysis can involve behavior analysis in which the system 100, including, for example, the recognition module or circuitry 128, can analyze and/or identify, from information captured by one or more vision sensors 120, patterns of movement and/or behavior of one or more individuals within a space to identify potential safety threats or hazardous behaviors. The database 130 can also provide a collection of behavior signatures that the recognition module or circuitry 128 can utilize in recognition of actions, from the captured information, that deviate from normal or anticipated actions, including, for example, actions that may be indicative of aggressive gestures, unauthorized entry attempts, and/or unusual congregation of individuals, which could indicate a presence of an actual, potential, or developing threat.

Additionally, or alternatively, the analysis by the recognition module or circuitry 128 at block 506 can include analyzing body posture, movement patterns, and the interaction between individuals near doors 206a-f associated with entry/exit points. According to such an embodiment, the recognition module or circuity 128 can identify suspicious behaviors such as, for example, approaching an entry/exit point and/or loitering with an apparent intent to engage in, or assist with, unauthorized entry.

At block 510, the results of the recognition analysis from block 508 can be evaluated with respect to certain, identified trigger criteria in connection with determining whether a security or safety response is to be at least initiated or implemented. Optionally, as indicated by block 512, at least some of the criteria that can be evaluated in connection with the results of the recognition analysis from block 508 can, according to certain embodiments, be dynamically adjustable (also identified herein as adjustable trigger criteria). For example, according to certain embodiments, the adjustable trigger criteria can include criteria that is adjusted based on changes in the associated sensitivity of the behavior analysis, including adjustments that may tolerate more types of behavior and/or the extent or degree identified actions by the individuals can be determined to be acceptable actions. The adjustable trigger criteria can be dynamically adjusted based on a variety of factors, including, for example, the time of day, the specific events/behavior/information identified at block 508, the events scheduled to be taking place at the corresponding location (e.g., during school pick-up/drop off hours), whether the captured information corresponds to outdoor or indoor activities, and/or the level of threat identified, as well as various combinations thereof, among other factors.

Factors in addition to those derived via recognition of the captured information can also be evaluated in connection with determining whether adjustable trigger criteria is satisfied, and/or with respect to adjusting the adjustable trigger criteria. For example, the information derived using the computer vision system 118, including the recognition modules or circuitry 128, can be evaluated in view of whether the current information indicates the lock mechanism 112 is, or is not, in a locked state, and/or if the associated door 206a-f is in the closed or open position. Additionally, such an analysis can further include, if the lock mechanism 112 is in the unlocked state and/or associated the door 206a-f is in the open position, whether there has been an authorization, such as, for example, a use of at least the credential reader device 108 that indicates the unlocked state of the lock mechanism 112 and/or the open position of the door 206a-f is, or is not, authorized. Additionally, if such a determination indicates that the lock mechanism 112 being in the unlocked state and/or the door 206a-f being in the open position appears, at least with respect to the use of credential device, to be authorized, the method 500 can further determine whether an authorized user of the credential device, or someone else, used the credential device to unlock the lock mechanism 112 and/or open the door 206a-f. For example, according to certain embodiments, the user of the credential device can be identified, or otherwise characterized, based on a physical size, behavior, including based on recordings of past behavior in the associated room 302a-c, 304 (e.g., a teacher often standing in the front of a classroom). All such information can be at least partially considered in determining at block 510 whether trigger criteria, such as, for example, detection of unauthorized actions, are satisfied.

Thus, at block 510, the identified trigger criteria, including any dynamically adjustable trigger criteria, can be evaluated in connection with the information extracted at least at block 508, among other information, to determine whether the trigger criteria has been satisfied. If the trigger criteria is determined to not be satisfied, such as, for example, the identified behavior derived at block 508 does not exceed what the trigger criteria may indicate is acceptable behavior, or other information that indicates the occurrence of authorized actions or activities, the method 500 can return to block 506, wherein the vision sensor(s) 120 can continue to capture information.

If, however, the determination at block 510 is the identified behavior derived at block 508 does exceed the trigger criteria, then at block 514 one or more signals can be generated by a controller 102 to facilitate actuation of the actuator 110 of the access control device 101 so that the lock mechanism 112 is placed in the locked state. Additionally, at block 516 the system 100 can communicate an alert, such as, for example, to a responder communication device 152 of the emergency system 154, and/or the I/O device 132, 136 of the access control management system 126 and/or auxiliary device 134. Additionally, according to certain embodiments, at block 518, the system 100 can utilize one or more auxiliary devices 134, including, for example, a speaker(s) 306a-d and/or sound sensor 308a-d (e.g., microphone) to establish two-way communication with one or more of the individuals captured in the captured information from block 506. An identification of which auxiliary devices 134 to operate can be based, at least in part, on an identification of the location of the captured information, as may be determined via use of at least the information recorded/identified at blocks 502 and 504. Such an alert to particular components of the system 100 can further be enhanced via use of a cloud platform 150, which may be configured to integrate various hardware devices, including hardware devices from various manufacturers or physical access control partners, to ensure the alert is delivered to the appropriate devices or personnel.

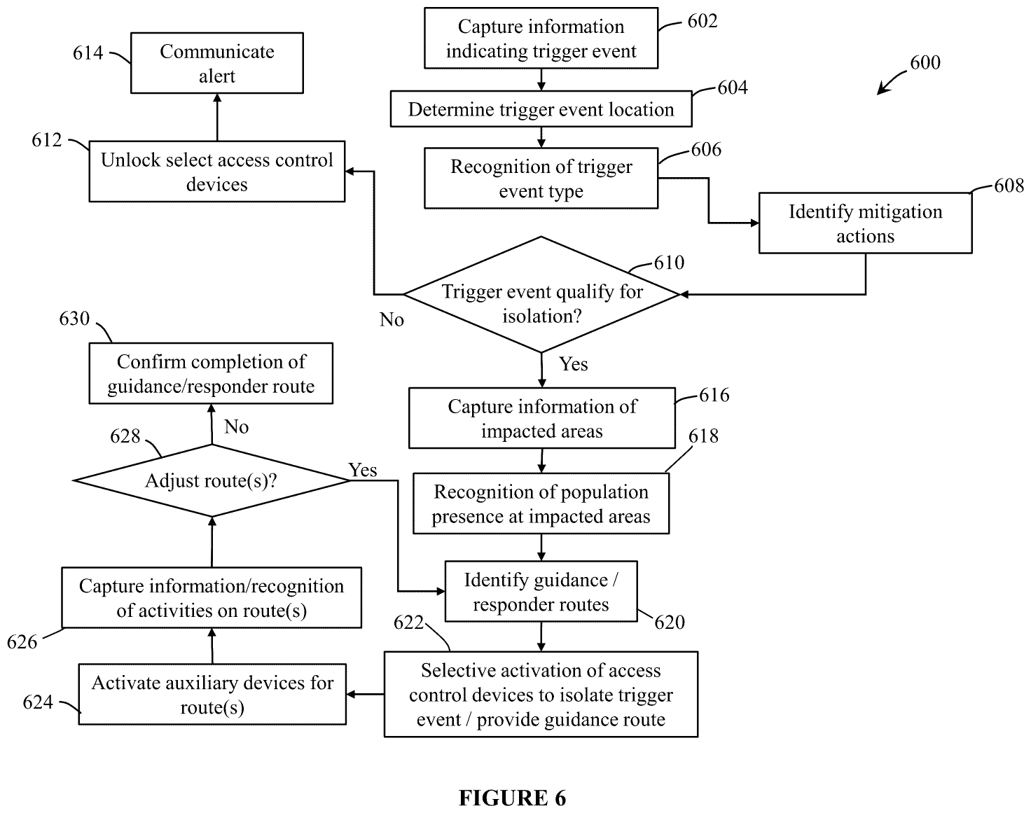

FIG. 6 illustrates an exemplary method 600 for emergency lockdown and wayfinding by the illustrated security management system 100. The system 100 and method 600 can be configured to, in certain situations, activate a smart lockdown protocol that not only can isolate a detected threat by locking one or more specific zones or areas, but can also guide occupants towards safe exits using strategically placed auxiliary devices 134, such as, for example, digital signage 310a, 310b and lighting cues from one or more lights 304a-f. The wayfinding capability of the system 100 and method 600 can be particularly beneficial during high-stress events, providing clear and calm instructions to guide people safely out of a building or structure. Further, the system 100 can be configured to assist first responders by highlighting, including, for example, by selective operation of one or more auxiliary devices 134, the fastest routes, as identified by the system 100, to the emergency source, which can thereby optimize response times.

With respect to the exemplary method 600 illustrated in FIG. 6, at block 602 one or more vision sensors 120 can capture information that may contain, or indicate, the presence of a trigger event, such as, for example, information associated with a presence of a man-made or caused emergency event, and/or an emergency event associated with a natural disaster, among other emergency events. In this example, the trigger event can be based on a variety of different conditions, including, for example, based on the behavior of one or more individuals and/or the presence of a hazardous condition(s), such as, for example, a fire, among other types of emergencies. Further, at block 604, a location associated with the information captured at block 602 can be identified and/or determined. Such location information can be determined, for example, in a manner that is at least similar to that discussed with respect to the method 500 illustrated in FIG. 5.

At block 606, the recognition module or circuitry 128 can analyze the captured information that was obtained at block 602 to determine whether the captured information indicates, or does not indicate, the presence of the trigger event(s). Additionally, if the capture information is determined to indicate the presence or occurrence of one or more trigger events, at block 606 the recognition module or circuitry 128 can identify the type of trigger event(s). For example, according to certain embodiments, at block 606, using the captured information, the recognition module or circuitry can identify a trigger event as being associated with an environmental hazard, such as, for example a fire, and/or associated with the actions of one or more individuals. An identification of the type of trigger event(s) can be utilized in connection with at least determining the appropriate response, including, with respect to, whether to initiate lockdown of any access control devices 101 and/or with respect to communications pertaining to the detected trigger event, including, for example, whether to communicate an alert to one or more responder communication devices 152, an emergency system 154, an I/O device 132, 136, a cloud platform 150, and/or selective operation of one or more types of auxiliary devices 134, as well as various combinations thereof, among other actions.

According to certain embodiments, recognition of the type of trigger event, as identified at block 606, can be used by one or more controllers 120 at block 608 to proactively determine an appropriate mitigation action. At least some of such mitigation actions, according to certain embodiments, may not involve the access control device 101 and/or the auxiliary device 134. For example, at least certain mitigation actions can include actions to prevent, or deter, threats, among other issues, including, for example, trimming landscape, managing parking lot traffic, removing barriers and/or items or debris that may be used as potential weapons, identifying areas in which illumination or lighting is to be improved, and/or droopy/worn hardware that is in need of maintenance, among other actions. According to such an embodiment, one or more controllers 102 can generate one or more signals to provide a notification of such identified mitigation actions, including, for example, to a responder communication device 152, I/O device 132, 136, cloud platform 150, and/or one or more types of auxiliary devices 134, as well as combinations thereof, among other devices or systems.

According to certain embodiments, for at least certain types of identified trigger events, the system 100 can be configured to, by default, either lock or unlock the lock mechanisms 112 of one or more, if not all, access control devices 101. Additionally, or alternatively, according to the illustrated embodiment, at block 610, one or more controllers 102 can determine whether the type of trigger event, as identified at block 606, qualifies for at least attempting to isolate the area(s), as identified at block 604, such as, for example, a lockdown of one or more rooms, areas, and/or zones, and/or provide a safe exit for other rooms, areas, and/or zones. Thus, in such an example, if the identified trigger event does not qualify for isolating one or more areas, than at block 612 the lock mechanisms 112 of one or more access control devices 101 can be placed in the unlocked state. Further, such a determination can also result in one or more controllers 102 generating an alert at block 614 relating to the identified trigger event(s) to a responder communication device 152, I/O device 132, 136, cloud platform 150, and/or one or more types of auxiliary devices 134, as well as various combinations thereof, among other devices or systems.

If at block 610 the identified trigger event is of the type that qualifies for isolation, then, to the extent not already obtained, at block 616 one or more vision sensors 120 can be operated to capture information of the area(s) that are, or may potentially be, impacted by the identified trigger event. Such captured information can be utilized at block 618 to identify the presence of one or more individuals in areas that are impacted, or may be impacted, by the trigger event. Moreover, an identification of the presence of one or more individuals in certain areas, as well as an identification or knowledge of the location of those areas can, at block 620, be utilized by one or more controllers 120 to determine one or more guidance routes for the evacuation for, and/or crowd management of, those individuals. Additionally, such location information, among other information, can also be utilized by one or more controllers 120 to generate a route(s) for responders to either reach the identified individuals and/or to travel to the location of the identified trigger event.

At block 622, one or more controllers 102 can be utilized to generate signals to selectively operate one or more access control devices 101. For example, with respect to the guidance and responder routes generated at block 620, such signals can be utilize to place the lock mechanism 112 of one or more access control devices 101 in an unlocked state such that the corresponding individuals that are traveling, or are to travel, along the associated route generated at block 620 can pass through entryways associated with those access control devices 101. Thus, for example, which particular access control devices 101 are to be placed in an unlocked state can be based on the generated route from block 620 and the entry/exit points associated with traveling along those identified routes. Additionally, at block 622, one or more controllers 120 can identify the particular access control devices 101 that are, to the extent not already in the locked state, to have the corresponding lock mechanism 112 placed in the locked state so as to isolate the identified trigger event(s). According to certain embodiments, such activation relating to the access control device 101 can further include activation of one or more actuators 110 that can facilitate the associated passageway device (e.g., door 206a-f) being, if necessary, moved to the closed position so that the passageway device can be locked in the closed position.

Additionally, at block 624, one or more auxiliary devices 134 can be selectively operated so as to assist in the guidance of individuals along the guidance route, as well as the guidance of responders along the responder route. The manner in which the auxiliary devices 134 are operated can vary for different types of auxiliary devices 134. For example, with respect to auxiliary devices 134 that are lights 304a-f, certain lights 304a-f can be illuminated, or illuminated to different levels, than other lights 304a-f so as to provide an indication of the path that is to be followed. Additionally, according to certain embodiments, the color and/or illumination pattern for at least certain lights 304a-f can be adjusted in a manner that can assist in providing an indication of the path that is to be followed. Additionally, according to certain embodiments, one or more signs 310a, 310b can be illuminated or provide messages in a manner that can assist with guiding the travel or movement of individuals, including responders. Further, speakers 306a-d and/or sound sensors 308a-d (e.g., microphones) can also be utilized to communicate information that can assist in guiding individuals, including responders, along the identified guidance/responder routes.

As individuals follow the guidance route, and/or responders follow the responder route, one or more vision sensors 120 can, at block 626, be selectively utilized to capture information regarding the movement of the individuals/responders, and/or relating to the location, or change thereof, of the trigger event(s). Such captured information can also include detection of movement, or an expansion or spreading, of the trigger event and/or the associated impact of the trigger event. Such information can be utilized at block 626 by at least the recognition module or circuitry 128 in connection with monitoring the overall situation. For example, information obtained using the recognition module or circuitry 128 from the information captured at block 628 can be utilized to determine whether to adjust the guidance route, the responder route, and/or the locked/unlocked status of one or more access control devices 101. For example, according to certain embodiments, detection of movement of the trigger event at block 626 can result in modifying the guidance/responder route at block 620 and/or adjusting, at block 622, which access control devices 101 are, or are not in the locked/unlocked state in a further attempt to isolate the trigger event and its associated potential impact. Additionally, or alternatively, such a modification of the guidance route and/or responder route can correspond to having the associated individuals/responders reaching an associated identified destination within a particular time period (e.g., within five minutes).

According to certain embodiments, at block 630, captured information from one or more vision sensors 120 can be utilized to determine whether individuals have completed the guidance route and/or responder route, including, for example, arrived at a destination associated with the guidance route and/or responder route. According to certain embodiments, such a destination can correspond to individuals reaching a location at which the individuals have evacuated the associated building (e.g., reaching an associated parking lot), and/or responders have reached the identified trigger event(s).

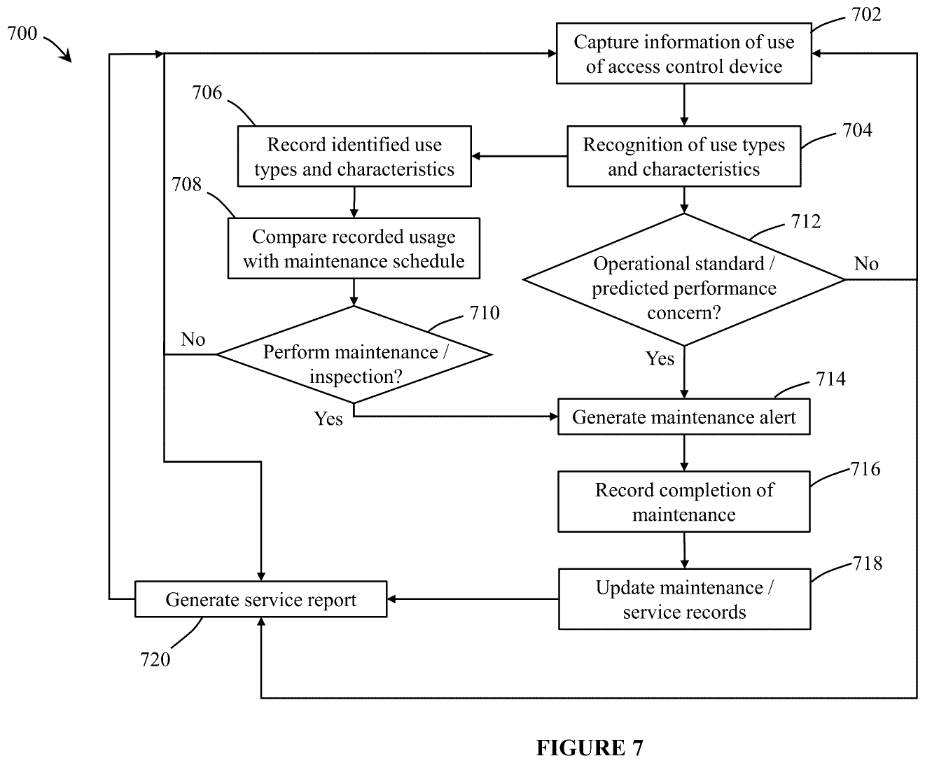

FIG. 7 illustrates an exemplary method 700 for preventive maintenance and broken door detection, as well as detection of compliance with regulations, by the illustrated security management system 100. According to certain embodiments, the method 700 can provide generally continuous monitoring of security hardware, including, but not limited to, the locks, exit devices, doors, and door closers, via use of the computer vision system 118 and/or the recognition module or circuity 128 to detect, including predict, maintenance needs and/or failures with the security hardware before such maintenance needs or failures impact security integrity. According to certain embodiments, the recognition module or circuity 128 can utilized captured information from one or more vision sensors 120 to analyze usage patterns and detect early signs of wear or malfunction in one or more portions of security hardware. Based on such determinations, the system 100 can schedule, or otherwise provide a notification of the need for, preventative maintenance. Such a predictive approach can ensure that security hardware remains operational, and reduce the risk of unauthorized access due to a failure of the security hardware.

Additionally, the system 100 can utilize the method 700 to at least assist in the system 100 adhering to regulatory standards and guidelines, including in sectors such as education and healthcare, among others. The system 100 can also facilitate compliance by automating security measures in alignment with standards such as those from the Partner Alliance for Safer Schools (PASS), among other regulatory bodies. By utilizing the computer vision system 118 to conduct thorough inspections and automatically complete punch lists, the system 100 can at least attempt to ensure that security hardware is installed and functioning as required, which can streamline the process of meeting and maintaining compliance standards. Further, such an approach can support proactive security measures also well as drive updates to PASS recommendations, including, for example, by incorporating parking lot perimeter video analytics as part of Tier 4 security enhancements.

With respect to the exemplary method 700 illustrated in FIG. 7, at block 702 one or more vision sensors 120 can capture information regarding the usage of security hardware, including, for example, an access control device 101 and/or the associated credential reader 108, actuator 110, lock mechanism 112, and/or door 206a-f, among other security hardware. At block 704, the recognition module or circuitry 128 can analyze the information captured at block 702 to identify the types of security hardware being utilized, as well as the nature of the use of that security hardware. Such identification of the use of the security hardware can, according to certain embodiments, be recorded, such as, for example, be a recording stored at a database 130 in a manner that can be used to track or log usage of the security hardware. Such tracking or logging of the usage of the security hardware can be utilized in connection with determining if, or when, certain security hardware is to undergo a preventive maintenance procedure and/or be replaced, as generally indicated by block 708. For example, the number of times an actuator 110 has been utilized to displace a bolt 212 of the lock mechanism 112 between the locked and unlocked state can be recorded at block 706. Such recorded information from block 706, as well as associated maintenance schedule information, as may be attained from a database 130 at block 708, can be used to determine, at block 710, whether, or when, the actuator 110, or components of the lock mechanism 112 are to be serviced or replaced.

At block 704, the recognition module or circuitry 128 can identify, from the captured information, certain characteristics of the operation of the identified security hardware. Such characteristics can, for example, correspond to the performance, including operation, of the security hardware or portions thereof, including, for example, the manner in which the security hardware moves, responds to movement, returns to home positions, and/or the responsiveness to commands from one or more controller 102, among other operational features. Further, the identified characteristics from block 704 can be evaluated at block 712 to determine, including predict, whether the security hardware has an, or is demonstrating characteristics associated with a potential, operational issue, including, for example, a failure in operation, among other performance issues.

If an actual or predicted maintenance issue is identified at either block 710 or 712, then at block 714, one or more controllers 128 can generate one or more signals that facilitate a notification of a need for maintenance of the security hardware. Additionally, or alternatively, the controller 102 can schedule maintenance for the security hardware, including, for example, with a maintenance schedule that may be maintained by, or accessible to, the system 100. Such a notification can be communicated, for example, to one or more I/O devices 132, 136, a responder communication device 152, and/or the cloud platform 150. Further, completion of maintenance, including repairs, to the security hardware can similarly be recorded on the system 100 at block 716, and the maintenance and service records can be updated accordingly at block 718. Further, one or more controllers 102 can utilize the updated maintenance or service records, as well as information derived at least at block 704 to, at block 720, generate service reports, and/or in association with an audit or other compliance certification that may be required by one or more regulations or association guidelines. Additionally, the information gathered by the method 700 can also be communicated to one or more manufacturers of the security hardware in connection with reporting potential design or manufacturing issues and/or areas for improvement, as well as reporting other information.

While the foregoing examples are discussed in connection with the use of the computer vision system 118 for identifying actual, or predicted, maintenance or performance issues for security hardware, such a method 700 can be utilized for a variety of other issues. For example, such an approach can be utilized following installation of security hardware, including with respect to confirming proper operation of new, or recently installed, security hardware. Thus, in some embodiments, at least a portion of the method 700 can be utilized in connection with completing a punch list relating to an inspection of an installation of security hardware, such as, for example, doors and entryways, in a building.

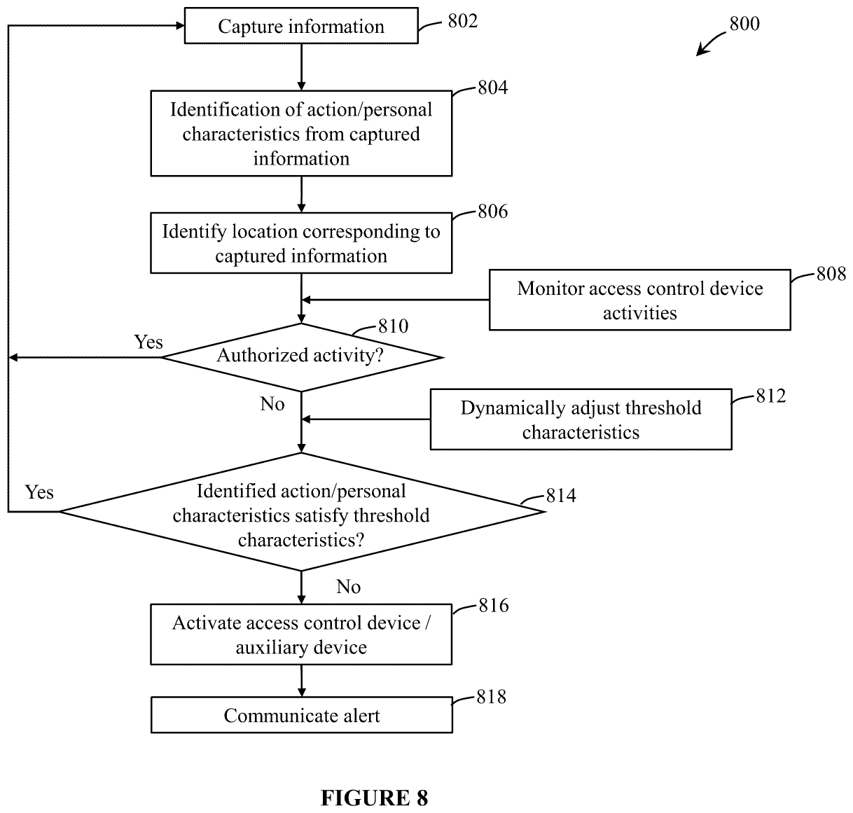

FIG. 8 illustrates an exemplary method 800 for detection of individual intent and an associated response by the illustrated security management system 100. As indicated above with respect to at least method 500 illustrated in FIG. 5, the method 800 can go beyond mere motion detection near access points (e.g., entry/exit points) to analyze the intent behind actions near access points, including by doors 120a-f, in rooms 302a-c and/or in hallways 304, among other locations. By interpreting body features, including body language, movement speed, and/or direction, among other body features and, optionally, in view of other data, including for example time-of-day data, unlocked/locked status of the lock mechanism 112, door 206a-f open/closed position, and/or event schedules, among other data, the methods 500, 800 can distinguish between routine access requests and potential security risks, such as loitering or unauthorized attempts to open doors 206a-f. Such a nuanced analysis can help reduce false alarms and at least attempt to ensure that security resources are focused on actual or real threats.

At block 802, information can be captured by one or more vision sensors 120 and be analyzed at block 804 using, for example, the recognition module or circuitry 128. The recognition at block 804 can include identification of actions by one or more individuals in the captured information. Such activity can include, but is not limited to, body features of the one or more persons within the captured information, including, for example, body features relating to body language, movement speed, and direction. For example, such identification via use of the computer vision system 118 can include the recognition module or circuitry 128 determining, from the captured information, whether a teacher(s) and/or student(s) is/are depicted in the captured information, as well as the location of the individual(s), such as whether the individual is in a room 302a-c or is wandering in a hallway 304. Further, such recognition at block 804 can be similar to that previously discussed with respect to at least block 508 for the method 500 illustrated in FIG. 5. Additionally, the location of the captured information being recognized at block 804 can be identified, including determined, at block 806 by at least one or more controllers 102.

The information obtained via the recognition module or circuitry 128 can be paired with other information, including, for example information regarding a status of an access control device(s) 101, door(s) 206a-f, and/or credential device. For example, at block 808, a controller 102 can monitor the activity at one or more access control devices 101 at least at the area corresponding to the location identified at block 806. Such monitoring can include, for example, an identification of whether an associated lock mechanism 112 is in an unlocked state or a locked state, as well as whether the corresponding door 206a-f is at the open position or closed position. Additionally, such an analysis at block 808 can include determining, if the lock mechanism 112 is in the unlocked state and/or the corresponding door 206a-f is in the opened position, whether information indicates such a current status of the lock mechanism 112 and/or door 206a-f was/is authorized, including, for example, authorized via an authentication process that involved at least the credential reader device 108.

The information obtained from at least blocks 804 and 808 can be utilized by one or more controllers 102 at block 810 in at least an attempt to identify whether the actions identified from the captured information at block 804 correspond to an authorized activity. For example, a combination of a particular body feature, as determined by the recognition module or circuity 128, and an indication that authorization was granted prior to the door 206a-f being displaced to the current open position and/or the lock mechanism 112 currently being in the unlocked state, may at least partially contribute to one or more controllers 102 determining, at block 810, that the activity identified at block 804 by use of the computer vision system 118 is authorized. Additionally, such determination of whether the activity is authorized can be utilized to control whether the door 206a-f is to be opened and/or the lock mechanism 112 is to be placed in the unlocked state. Aside from providing security measures, such an approach can also be utilized to prevent or eliminate nuisance opening/closing of doors 206a-f by an unauthorized pedestrian.

If such an activity is determined at block 810 to be authorized, the method 800 can return to block 802, wherein the one or more vision sensors 120 can continue to capture information at, or around, one or more access points (e.g., entry/exit points). However, if a determination is made by the one or more controllers 102 at block 810 that the activity is not authorized, then at block 814 the one or more controllers 102 can determine whether the identified action or personal features satisfy certain threshold characteristics. The threshold characteristics can vary for different applications and, according to certain embodiments, can be dynamically adjustable. For example, similar to block 512 of the method 500 shown in FIG. 5, the threshold characteristics can be determined at block 812. According to certain embodiments, the adjustable threshold characteristics adjusted at block 812 can be similar to, if not the same as, the previously discussed dynamically adjustable trigger criteria discussed in block 512, and therefore, can also be adjusted in similar manners. Further, if the controller(s) 102 determine at block 814 that the threshold characteristics are satisfied, then the method 800 can return to block 802, wherein the one or more vision sensors 120 can continue to capture information at, or around, one or more entry/exit points.

However, if the controller(s) 102 determines at block 814 that the threshold characteristics are not satisfied, the method 800 can proceed to block 816, wherein one or more identified access control devices 101 and/or one or identified more auxiliary devices 134 can be selectively activated via one or more signals generated by the controller(s) 102. For example, according to certain embodiments, the identified location corresponding to the captured information, as determined at block 806, can be used to identify the particular associated access control device(s) 101 and/or auxiliary device(s) 134 that are to be activated. Such activation can include, for example, generating one or more signals for operation of the actuator 110 in a manner that can result in the associated door(s) 206a-f being displaced to the closed position and/or the lock mechanism 112 of the auxiliary device(s) 101 being placed in the locked state. Thus, the selective activation of the access control devices is 101 and/or auxiliary devices 134 at block 816 can be similar to that discussed above with respect to at least block 514 of the method 500 illustrated in FIG. 5. Additionally, similar to block 518 of the method 500, at block 818 a controller(s) 102 can generate one or more signals to output an alert, such as, for example, via use of an I/O device 132, 136, a responder communication device 152, and/or via the cloud platform 150.

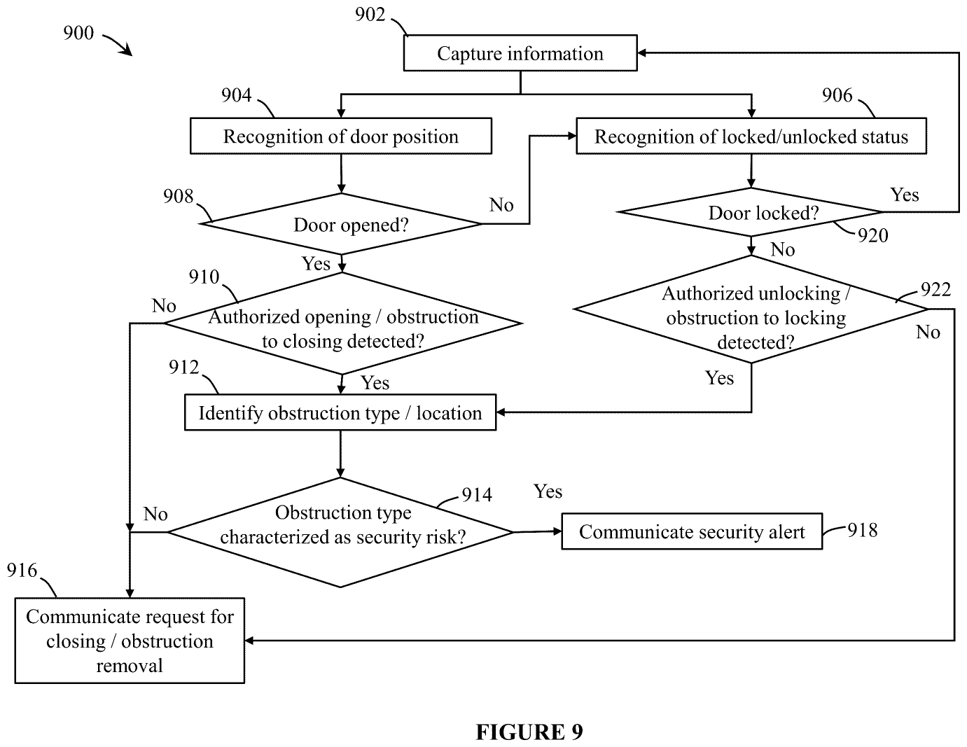

FIG. 9 illustrates an exemplary method 900 for detection of a lock state or passageway device position by the illustrated security management system 100. The illustrated method 900 provides an exemplary demonstration of a capability of the system 100 to determine the status of one or more doors 206a-f and/or the associated access control device 101. An example of such a status determination can include, for example, determining whether the lock mechanism 112 is in the locked state or the unlocked state, and, if in the unlocked state, whether being in the unlocked state is/was authorized. Another example of such a status determination can include, for example, determining whether the door 206a-f is in the opened position or the closed positioned, and, if in the opened position, whether being in the opened positioned is/was authorized. Such determinations can result, for example, in a determination as to whether a door 206a-f is improperly being propped opened. Such a determination can also provide an indication as to whether the lock mechanism 112 is not being allowed return to the locked state, such as, for example, via an obstruction being placed in or around the strike hole or mortise 214 and/or strike plate 216 that prevents the bolt 212 from extending to the extended position associated with the lock mechanism 112 being in the locked state.

According to certain embodiments, the exemplary method 900 can include the system 100 utilizing a combination of computer vision, as provided by the computer vision system 118, and infrared (IR) technology, including via use of the above-discussed emitter/receiver 142 of the sensor system 140. The use of IR technology can allow for the identification of obstructions or tampering attempts that might not be visually apparent, such as an insertion of materials into the strike plate(s) 216 to prevent locking of the door(s) 206a-f by the associated lock mechanism 112 in a closed position. Moreover, in connection with attempting to ensure that all entry/exit points remain secure, the computer vision system 118 can be utilized to detect the presence of objects like wedges or bricks being used to prop a door(s) 206a-f open.

Additionally, or optionally, the system 100 can be configured to detect visual indicators or representations, among other indicia, such as the above-discussed markers 220a, 220b, on at least a portion of the lockset 220 that provide a visual indication of the current locked state or unlocked state of the lock mechanism 112, and/or visually indicate if door 206a-f, among other passageway devices, is left ajar or has been tampered with. For example, the markers 220a 220b can provide mechanical indicators that can serve as visual signals for the computer vision system 118 of door and/or lock status without requiring electronic components. As previously discussed, such markers 220a, 220b, among other indicators, can be designed to change appearance or position in response to specific security or safety events, such as, for example the door 206a- f being in the opened position or the closed position, and/or the lock mechanism 112 being in the locked state or the unlocked state. The computer vision system 118 can be utilized to detect the information conveyed by the markers 220a, 220b, and/or a change in the information being conveyed by the markers 220a, 220b, and relay the information to the access control management system 101, the responder communication device 152, and/or the cloud platform 150 so as to alert security personnel. Such an approach can provide a cost-effective solution for enhancing security monitoring in environments where electronic upgrades may not be feasible.

Additionally, according to certain embodiments, the emitter/receiver 142 of the sensor system 140 can be a plurality of emitter/receiver combinations that provide the sensor system 150 with different types of sensing capabilities. For example, according to certain embodiments, the emitter/receiver 142 can include a first emitter/receiver 142 that utilizes a first sensing technology, such as, for example, IR, and a second emitter/receiver 142 that utilizes a different, second sensing technology, such as, for example, radar technologies, among others. According to such an embodiment, the system 100 can employ a combination of the first and second sensing technologies (e.g., IR and radar technologies) to detect and localize obstructions. Once an obstruction is identified, the computer vision 118 can be used to classify the object and determine whether the detected object poses a security risk, or, alternatively, if the detected object simply needs to be removed. Such features can be particularly useful with respect to embodiments in which one or more, if not all, of the doors 206a-f, are automatic sliding doors, and, moreover, in maintaining the operational efficiency of automatic sliding doors in high-traffic areas, ensuring that the sliding doors function smoothly without compromising security or safety.

Such comprehensive approaches to monitoring the status of the door(s) 206a-f and/or access control devices 101, including, for example, associated lock mechanisms 112 can be vital for maintaining security integrity within a building, including a facility.

With respect to the exemplary method 900 illustrated in FIG. 9, at block 902, one or more vision sensors 120 of the computer vision system 118 can be utilized to capture information that can include, for example, information regarding security hardware, including, for example one or more doors 206a-f and/or access control devices 101, including, but not limited to, a lockset 200.

At block 904, the computer vision system 118 and/or the recognition module or circuitry 128 can analyze the captured information from block 902 in connection with determining a door position for one or more doors 206a-f, such as, for example, determining whether the door 206a-f is in either the opened position or the closed position. For example, the vision sensor 120, such as, for example, a three-dimensional camera, can be configured to capture information that the recognition module or circuitry 128 can utilized to identify a position and/or orientation of the door 206a-f. Further, such positioning of the door 206a-f can also be determined by identifying locations of at least portions of the door 206a-f relative to other features in the captured information, including, for example, a location of an associated door jamb 218. Additionally, or alternatively, the captured information can include information transmitted by an infrared beacon, or otherwise provided by a smart badge or asset tracking that the recognition module or circuitry 128 can utilize to determine an open or closed position of the door 206a-f. Additionally, or alternatively, one or more makers 220a, 220b can be configured to adjust a visual indicator, including changing the visual indication of the visual indicator and/or changing the marker 220a, 220b from being concealed from at least the vision system 120 to being visible to the vision system 120 in response door 206a-f being one of the open or closed positions.

In addition, or as an alternative, to using the computer vision system 118 to determine a door position at block 904, at block 906, the computer vision system 118 and/or the recognition module or circuitry 128 can analyze the captured information from block 902 in connection with determining whether the lock mechanism 112 of one or more access control devices 101 is in either the locked state or the unlocked state. According to certain embodiments, this recognition can include identifying a current indicator provided by one or more of the markers 220a, 220b. For example, as previously discussed, the markers 220a, 220b can provide a visual representation, such as, for example, indicia, colors, or symbols, as well as various combinations thereof, among other visual identifiers, that provide an indication of the current state of the lock mechanism 112. Additionally, or alternatively, the computer vision system 118 can utilize the captured information from block 902 to identify a relative position of one or more of the markers 220a, 220b relative to at least another marker 220a, 220b or other reference point, with such relative positioning indicating the locked or unlocked state of the lock mechanism 112. Additionally, or alternatively, the computer vision system 118, including, for example, the recognition module or circuitry 128, can determine whether the marker 220a, 220b is, or is not, concealed or visible, which, according to certain embodiments can indicate the locked or unlocked state of the lock mechanism 112.

According to other embodiments, the captured information from block 902 can comprise an IR signal transmitted from an emitter 222a, 222b of the sensor system 140. In such an embodiment, a vision sensor 120, or other device, can operate as a receiver that receives the transmitted signal. The transmitted signal can include a variety of information, including, for example, information used at block 904 in determining the door position and/or used at block 906 in connection with determining the current locked or unlocked state of the lock mechanism 112. The information transmitted by an IR signal can also include information provided by one or more sensors, such as, for example, position sensors, used to identify the door position and/or locked/unlocked state of the lock mechanism 112. Additionally, the transmitted IR signal can include information regarding current or past attempts to open the door 206a-f and/or unlock the lock mechanism 112, including via operating the trim portion 202 and/or push bar assembly 204 without authorization, as well as failed attempts to attain authorization via at least use of the credential reader device 108. Such failed attempts at attaining authorization or to unlock the locking mechanism 112 and/or open the door 206a-f can also be provided by captured information attained by one or more of the vision sensors 120.

With respect to the recognition of the door position discussed above in regards to at least block 904, if the information indicates at block 908 that the door is at an open position, or, alternatively, is not at the closed position, then at block 910 one or more controllers 102 can be utilized to determine whether or not authorization had been granted for the opening of the door 206a-f. If the determination at block 910 indicates that authorization had not been granted for the opening of the door 206a-f, that at block 910 a further determination can be made as to whether the door 206a-f is being propped open by the presence of an obstruction. Thus, for example, at least a portion of the captured information provided at block 902 can be analyzed by the computer vision system 118 and/or the recognition module or circuitry 128 to attempt to identify the presence of an obstruction that may be interfering with the door 206a-f being placed in the closed position. Such an identification of an obstruction can be achieved in a variety of different manners, including, for example, by the use of information captured by one or more vision sensors 120 and/or via use of the sensor system 140 including, for example, a first sensing technology that may utilize IR and/or a second sensing technology that may utilize radar. According to certain embodiments, if a determination is made at block 910 that an obstruction is not present, then at block 916 the system 100 can communicate a notification, such as, for example, to a I/O device 132, 136, a responder communication device 152, and/or the cloud platform 150 requesting that the door 206a-f be closed. Additionally, or alternatively, kinetics of a user that may be associated with a credential device that received permission to open the door 206a-f can be detected and utilized to determine whether that individual, in addition to opening the door 206a-f, performed any action that could be associated with the placing an obstacle to prop or otherwise hold the door 206a-f in the open position and/or prevent the door 206a-f from being in the closed position.

If, however, at block 910 the computer vision system 118 and/or the recognition module or circuitry 128 identifies the presence of an obstruction that is preventing the closing of the door, then at block 912 the computer vision system 118 and/or the recognition module or circuitry 128 can be utilized to identify the type and/or location of the obstruction. For example, at block 912, the computer vision system 118 and/or the recognition module or circuitry 128 can use the captured information to identify whether the obstruction is a wedge, brick, kick down stop, or the like, as well as if the obstruction is at, or near the door, such that the obstruction is being used to prop the door open. Based on the identification of the type of obstruction, and/or the location of the obstruction, at block 914 one or more of the controllers 102 can determine whether the obstruction is of the type that can be characterized as a security risk. For example, a determination that the obstruction is a kick down stop may indicate that the obstruction can remain at the door 206a-f and is not part of a security risk. In such an event, the method 900 can proceed to block 916, wherein a notification can be communicated requesting that the door 206a-f be closed. Conversely, if at block 914, the obstruction is of the type that can be characterized as a security risk, then at block 918 one or more controllers 102 of the system 100 can generate an alarm indicating a detected presence of an actual or potential security risk. In such an event, security personnel, among others can be notified of a detected threat that is to be addressed. Thus, compared to the notification provided at block 916, the alert provided at block 918 can correspond provide an indication of a more significant event that may require more immediate attention, and can be communicated to a larger group of responders and/or emergency personnel.

Returning to block 906, or a determination at block 908 that the door 206a-f is not opened, the method 900 can further include using at least the recognition information from block 906 to, at block 920, determine whether the lock mechanism 112 is, or is not, in the locked state. If the determination is made, such as, for example, by one or more controllers 102 at block 920 that the lock mechanism 112 is in the locked state, then the method 900 can return to block 902, wherein additional information can be captured by at least the one or more vision sensors 120. If, however, the one or more controllers 102 determine at block 920 that the lock mechanism 112 is in an unlocked state, then at block 922 the one or more controllers 102 can determine whether authorization had been granted for the current unlocked state of the lock mechanism 112.

If the determination of block 922 indicates that authorization had not been granted for the unlocking of the lock mechanism 112, then at block 910 a further determination can be made as to whether the lock mechanism 112 is being prevented from being in the locked state, including, for example, via an obstruction preventing the bolt 102 from extending into the strike plate hole or mortise 214 and/or the strike plate 216. In such an event, at least a portion of the captured information provided at block 902 can be analyzed by the computer vision system 118 and/or the recognition module or circuitry 128 to attempt to identify the presence of an obstruction that may be interfering with the displacement of the bolt 212, among other obstructions to the operation of the lock mechanism 112 that may be preventing the lock mechanism 112 being in the locked state. Such an identification of an obstruction can be achieved in a variety of different manners, including, for example, by the use of information captured by one or more vision sensors 120 and/or via use of the sensor system 140 including, for example, a first sensing technology that may utilize IR and/or a second sensing technology that may utilize radar. As seen in FIG. 9, whether an obstruction is, or is not detected, can determine whether the process proceeds to either block 916, in which a notification is communicated, or to above-discussed block 914, wherein a determination is made as to whether the obstacle is, or is not, characterized as a security risk, and thus whether a notification or an alert is to be generated at either block 916 or 918, respectively.

In one implementation of the present disclosure, a method is provided for detecting unauthorized entry attempts. The method can include capturing real-time or near-real time video data at an access point, such as, for example, an entry point and/or exit point, and utilizing computer vision algorithms to determine a count of individuals passing through the entry/exit point. The method can also include comparing the count of individuals against a number of authenticated credentials presented to an access control device and identifying instances of tailgating or piggybacking based on discrepancies between the count of individuals and the number of authenticated credentials. Additionally, the method can further include initiating an alert or a security response based on the identified instances.

In one example of the method, an accuracy of a determination of the count can be improved, via machine learning, and based at least on a historical data and an identified instance of tailgating or piggybacking. According to another example, the method can further include disabling, at least temporarily, the authenticated credentials associated with the identified instances of tailgating or piggybacking.

In another example of an implementation of the present disclosure, a system is provided for behavior analysis and threat detection in a monitored environment. The system can include a vision sensor configured to capture information within the environment and at least one processor programmed with machine learning algorithms for analyzing the captured information to determine a behavioral analysis indicative of an identified threat. The identified threat can comprise one or more potential or actual safety threats or one or more hazardous behaviors. Additionally, or alternatively, the system can also include an interface to communicate with at least one access control device to initiate lockdown procedures to adjust secure/unsecure zone definitions based on the identified threat.

In one example of the system, the at least one processor can be further configured to dynamically adjust a sensitivity of the behavior analysis based on one or more of a time of day, an identified event occurring at the time of the vision sensor captures the information, and a characterization of a severity of the identified threat. Additionally, or alternatively, the at least one processor can be further configured to generate one or more signals for a transmission of an alert to a designated personnel when a behavior pattern of the behavioral analysis is identified by the at least one processor as being indicative of an immediate threat.

In a further example of an implementation of the present disclosure, a system is provided for detecting unauthorized assisted entry. The system can include a sensor for capturing information, a communication module, at least one processor, and a memory coupled with the at least one processor. The memory can include instructions that when executed by the at least one processor cause the at least one processor to detect, from the captured information, a presence of an individual in a vicinity of a door, analyze, from the captured information, a body kinetics and an interaction pattern of the individual to detect an unauthorized assisted entry scenario, and generate one or more signals to facilitate a transmission, from the communication module, of an alert in response to detection of the unauthorized assisted entry scenario.

In one example of the system, the memory can further include instructions that when executed by the at least one processor cause the at least one processor to generate, in response to detection of the unauthorized assisted entry scenario, one or more signals to facilitate an operation of one or more access control devices to initiate a lockdown procedure for one or more locksets. Additionally, or alternatively, the memory can further include instructions that when executed by the at least one processor cause the at least one processor to generate, in response to detection of the unauthorized assisted entry scenario, one or more signals to facilitate an operation of an auxiliary device, the auxiliary device comprising at least one of a speaker, a microphone, a light, and a sign. Additionally, optionally, the vision sensor can be a camera, and the captured information can include at least one of an image or a video. Further, the communication module is further configured to interface with a remote guarding service in a manner that can accommodate real-time or near real-time of an audio and/or visual communication with one or more individuals identified as involved in the unauthorized assisted entry scenario. The memory can further include instructions that when executed by the at least one processor can cause the at least one processor to improve, via machine learning, and based at least on a historical data and detection of at least one of the unauthorized assisted entry scenario, an accuracy of the detection of a future unauthorized assisted entry scenario.

In an additional example of an implementation of the present disclosure, an emergency management system is provided that can include one or more access control devices, a network of cameras configured to obtain a captured information, a computer vision system configured to process the captured information to detect an emergency situation, at least one processor, and a memory coupled with the at least one processor. The memory can include instructions that when executed by the at least one processor can cause the at least one processor to initiate, in response to the detection of the emergency situation, a smart lockdown protocol for the one or more access control devices, and generate, in response to the detection of the emergency situation, a guidance route for guiding occupants to a safety destination. The memory can also include instructions that when executed by the at least one processor can cause the at least one processor to generate, in response to the detection of the emergency situation, a responder route for directing a responder to a location of the emergency situation, and generate, in response to the detection of the emergency situation, an alert for at least one of a responder communication device, an emergency system, a cloud platform, and an input/output device of an access control management system.

In one example of the emergency management system, the memory can further include instructions that when executed by the at least one processor can cause the at least one processor to generate, in response to the detection of the emergency situation, one or more signals to facilitate an operation of an auxiliary device, the auxiliary device comprising at least one of a speaker, a microphone, a light, and a sign. Additionally, or alternatively, the light can be a dynamic lighting system, and the sign can be a digital sign configured to provide real-time or near-real time instructions and updates to occupants during an emergency. Further, the vision sensor can be a camera, and the captured information can comprise a video data. Optionally, the emergency management system can include a feedback auxiliary device that can be configured for either or both the occupants and the responders to provide real-time or near real-time status updates to facilitate an enhancement of a situational awareness and a response effectiveness.

In a further example of an implementation of the present disclosure, a predictive maintenance system for security hardware is provided. The predictive maintenance system can include a security hardware comprising a lockset and a door, and a computer vision system having one or more vision sensors. The computer vision system can be configured to analyze a captured data obtained by the one or more vision sensors to identify at least one of a usage pattern and a sign of a wear or a malfunction of a least a portion of the security hardware. The predictive maintenance system can also include at least one processor and a memory coupled with the at least one processor. The memory can include instructions that when executed by the at least one processor can cause the at least one processor to predict, based at least in part on the identification by the computer vision system of the usage pattern and the sign of the wear or the malfunction, a maintenance need for the portion of the security device, and generate, based on the prediction, a notification signal for a scheduling of a proactive maintenance activity for at least the portion of the security device.

In an example of the predictive maintenance system, the memory can further include instructions that when executed by the at least one processor can cause the at least one processor to generate one or more signals to communicate a report that includes information regarding one or both of the predicted maintenance need and the scheduling of the proactive maintenance activity. In another example, the memory further includes instructions that when executed by the at least one processor can cause the at least one processor to update, based at least on information from the report, one or more maintenance algorithms used by the computer vision system to identify the usage pattern and the sign of the wear or the malfunction.

In a further example of an implementation of the present disclosure, a method is provided for determining pedestrian intent. The method can include capturing video data of a pedestrian approaching or lingering near a security point and analyzing the captured video data using one or more computer vision algorithm to identify a body feature comprising at least one of a body language, a body movement speed, and a direction of movement. The method can further include comparing the body feature against a predefined criteria to determine an intent of the pedestrian, and implementing, based on the intent, a corresponding security or operational response.

In an example of the method, the corresponding security or operational response can comprise initiating a lock down procedure for one or more access control devices. Additionally, or alternatively, the method can include the corresponding security or operational response including initiating an operation of one or more auxiliary devices, the one or more auxiliary devices comprising at least one of a speaker, a microphone, a light, and a sign. Further, the corresponding security or operational response can comprise an alert or a notification for at least one of a responder communication device, an emergency system, a cloud platform, and an input/output device of an access control management system. Additionally, or alternatively, the corresponding security or operational response can comprise at least one of activating a physical barrier or locking mechanism to prevent access to through entryway and sending a notification to a security personnel for further assessment.

In an another example of an implementation of the present disclosure, a compliance facilitation system is provided for security installations is provided that can include a computer vision system comprising one or more vision sensors configured to obtain a captured data, the computer vision system being configured to analyze the captured data to verify an installation and a functionality of a security hardware in relation to a regulator standard. The compliance facilitation system can also include at least one processor and a memory coupled with the at least one processor. The memory can include instructions that when executed by the at least one processor can cause the at least one processor to generate, based at least in part on the analysis of the security hardware by the computer vision system, a compliance report, and receive and implement an update to the regulatory standard.

In an example, of the compliance facilitation system, the memory can further include instructions that when executed by the at least one processor can cause the at least one processor to a communicate information regarding the regulatory standard, including the update to the regulatory standard, to one or more input/output devices to train maintenance personnel.

In an another example of an implementation of the present disclosure, a security monitoring system is provided for determining a status a security hardware. The security monitoring system can include a computer vision system having a vision sensor configured to obtain a captured data, at least one processor, and a memory coupled with the at least one processor. The memory can include instructions that when executed by the at least one processor can cause the at least one processor to identify, using the captured data, the status of the security hardware, the status comprising at least one of a door position and a locked/unlocked state of a lock mechanism, and identify, using the captured data, a presence of an obstruction at a location that prevents a change in the status of at least one of the door position and the locked/unlocked state of the lock mechanism. The memory can further include instructions that when executed by the at least one processor can also cause the at least one processor to characterize, using the captured data, an obstruction type for the type of obstruction, and determine, based on the characterization of the obstruction type, a response to the detection of the obstruction, wherein the response includes at least one a generation of an alert or a notification, the alert being communicated to at least some recipients that are different then recipients that receive the notification.

In an example of the security monitoring system, the security hardware includes at least one emitter, and the vision sensor includes at least one receiver, the emitter configured to emit a signal using at least one sensing technology that is received by the receiver, the at least one sensing technology comprising at least one of an infrared sensing technology and a radar sensing technology. In another example of the security monitoring system, the signal includes information indicative of an unauthorized attempt to adjust the door position and/or adjust the status of the lock mechanism. Additionally, the security hardware can further include one or more markers having a visual representation or a concealable appearance that is detectable by the vision sensor, the visual representation or the concealable appearance being adjusted in response to a change in one or both of the door position and the status of the lock mechanism. Additionally, the memory can further include instructions that when executed by the at least one processor can cause the at least one processor to initiate a maintenance request or an alert in response to the door position having, for a predetermined period of time, a status indicative of the door not being in a closed position.

In an additional example of an implementation of the present disclosure, a method is provided for detecting unauthorized entry attempts. The method can include receiving, by a credential device, a credential relating to an authorization status for an operation of an access device associated with the credential device. The method can also include capturing, via use of a vision system, a first captured data around at least one of the credential device and an access point corresponding to the access device, and identifying, using the first captured data, a first count of one or more individuals at one or more of the credential device and the access point. Further, an determination can be made as to whether the authorization status permits a passage through the access point, as well as whether the first count satisfies a first threshold value. The method can also include activating an unlocking of the access device in response to the authorization status being determined to permit the passage through the access point and the first count being determined to satisfy the first threshold value.

In one example, the method can also include denying the unlocking of the access device in response to the first count being determined to not satisfy the first threshold value. Additionally, or alternatively, the method can further include identifying, from the credential, an individual associated with credential, determining whether the identified individual associated with the credential is detected in the first captured data, and denying the unlocking of the access device in response to the individual associated with credential being determined to not be detected in the first captured data. In another example, the method can include one or more of capturing, via use of the vision system, a second captured data after at least the unlocking of the access device, determining, using the second captured data, a second count of individuals representative of a number of one or more individuals that passed through the access point after the unlocking of the access device and prior to a subsequent locking of the access device, determining whether the second count satisfies a second threshold value, and generating an alert in response to the second count of individuals being determined to not satisfy the second threshold value. Further, the method can include the second threshold value being the same as the first threshold value. In another example, the method can include one or more of capturing, via use of the vision system, a second captured data after at least the unlocking of the access device, generating an alert at least in response to an inability to identify, using the second captured data, an identity of one or more individuals that passes through the access point between the unlocking of the access device and before a subsequent locking of the access device. Additionally, the method can include one or more of capturing, via use of the vision system, a second captured data after at least the unlocking of the access device, identifying, using the second captured data, an identity of one or more individuals that passes through the access point between the unlocking of the access device and before a subsequent locking of the access device, and determining the authorization status for the identified one or more individuals.

In an additional example of an implementation of the present disclosure, a method is provided for detecting unauthorized entry attempts. The method can include, for example, one or more of determining a number of credentials detected at a credential device, capturing, via use of a vision system, a first captured data around at least one of the credential device and an access point corresponding to the credential device, identifying, using the first captured data, a first count of one or more individuals, and activating an unlocking of an access device corresponding to the access point at least in response to the first count being determined to satisfy the number of credentials.

In one example, the method can also include the first count satisfying the number of credentials based on the first count being the same as the number of credentials. Optionally, the method can also include denying passage through the access point in response to the first count of individuals being determined to not satisfy the number of credentials Additionally, or alternatively, the determining the number of credentials detected at the credential device can comprise determining the number of credentials detected at the credential device having an authorization status that authorizes the unlocking of the access device. The method can also include one or more of capturing, via use of the vision system, a second captured data after at least the unlocking of the access device, determining, using the second captured data, a second count of individuals representative of a number of one or more individuals that passed through the access point, determining whether the second count satisfies a second threshold value, and generating an alert in response to the second count being determined to not satisfy the second threshold value. Additionally, the second threshold value can be the same as the number of credentials. Further, the method can include either or both capturing, via use of the vision system, a second captured data after at least the unlocking of the access device, and generating an alert at least in response to an inability to identify, from the second captured data, an identity of one or more individuals that passes through the access point between the unlocking of the access device and before a subsequent locking of the access device. Additionally, the method can include one or more of capturing, via use of the vision system, a second captured data after at least the unlocking of the access device, identifying, using the second captured data, an identity of one or more individuals that passes through the access point between the unlocking of the access device and before a subsequent locking of the access device, and determining an authorization status for the identified one or more individuals, the authorization status corresponding to an authorization for the unlocking of the access device.

In an additional example of an implementation of the present disclosure, a method is provided for detecting unauthorized entry attempts that can include one or more of identifying, via use of a credential device, one or more credentials for one or more individuals, unlocking, based on an authorization status associated with at least one credential of the one or more credentials, an access device for an access point corresponding to the credential device, capturing, using a vision system, a first data corresponding to the access point, the first data being captured at least after the unlocking of the access device and before a subsequent locking of the access device, determining, using the first data, a first count of one or more individuals that passed through the access point, and generating an alert in response to the first count not satisfying a first threshold value.

In one example, the method can also include comparing the first count to the first threshold value. Additionally, the method can further comprise determining a number of the one or more credentials identified via use of the credential device, and wherein the first threshold value corresponds to the number of the one or more credentials. Optionally, the first threshold value can correspond to a number of the one or more credentials having authorization for the unlocking of the access device. Further, the method can include one or more of determining a number of the one or more credentials identified via use of the credential device, detecting, using a second information captured by the vision system, a second count of individuals around at least one of the credential device or access point, and preventing the unlocking of the access device in response to a determination that the number of the one or more credentials does not satisfy the second count.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A method for detecting unauthorized entry attempts, the method comprising:
receiving, by a credential device, a credential relating to an authorization status for an operation of an access device associated with the credential device;
capturing, via use of a vision system, a first captured data around at least one of the credential device and an access point corresponding to the access device;
identifying, using the first captured data, a first count of one or more individuals at one or more of the credential device and the access point;
determining whether the authorization status permits a passage through the access point;
determining, whether the first count satisfies a first threshold value; and
activating an unlocking of the access device in response to the authorization status being determined to permit the passage through the access point and the first count being determined to satisfy the first threshold value.

2. The method of claim 1, further comprising, denying the unlocking of the access device in response to the first count being determined to not satisfy the first threshold value.

3. The method of claim 1, further comprising:
identifying, from the credential, an individual associated with credential;
determining whether the identified individual associated with the credential is detected in the first captured data; and
denying the unlocking of the access device in response to the individual associated with credential being determined to not be detected in the first captured data.

4. The method of claim 1, further comprising:
capturing, via use of the vision system, a second captured data after at least the unlocking of the access device;
determining, using the second captured data, a second count of individuals representative of a number of one or more individuals that passed through the access point after the unlocking of the access device and prior to a subsequent locking of the access device;
determining whether the second count satisfies a second threshold value; and
generating an alert in response to the second count of individuals being determined to not satisfy the second threshold value.

5. The method of claim 4, wherein the second threshold value is the same as the first threshold value.

6. The method of claim 1, further comprising:
capturing, via use of the vision system, a second captured data after at least the unlocking of the access device; and
generating an alert at least in response to an inability to identify, using the second captured data, an identity of one or more individuals that passes through the access point between the unlocking of the access device and before a subsequent locking of the access device.

7. The method of claim 1, further comprising:
capturing, via use of the vision system, a second captured data after at least the unlocking of the access device;
identifying, using the second captured data, an identity of one or more individuals that passes through the access point between the unlocking of the access device and before a subsequent locking of the access device; and
determining the authorization status for the identified one or more individuals.

8. A method for detecting unauthorized entry attempts, the method comprising:
determining a number of credentials detected at a credential device;
capturing, via use of a vision system, a first captured data around at least one of the credential device and an access point corresponding to the credential device;
identifying, using the first captured data, a first count of one or more individuals; and
activating an unlocking of an access device corresponding to the access point at least in response to the first count being determined to satisfy the number of credentials.

9. The method of claim 8, wherein the first count satisfies the number of credentials based on the first count being the same as the number of credentials.

10. The method of claim 8, further comprising denying passage through the access point in response to the first count of individuals being determined to not satisfy the number of credentials.

11. The method of claim 8, wherein determining the number of credentials detected at the credential device comprises determining the number of credentials detected at the credential device having an authorization status that authorizes the unlocking of the access device.

12. The method of claim 8, further comprising:
capturing, via use of the vision system, a second captured data after at least the unlocking of the access device;
determining, using the second captured data, a second count of individuals representative of a number of one or more individuals that passed through the access point;
determining whether the second count satisfies a second threshold value; and
generating an alert in response to the second count being determined to not satisfy the second threshold value.

13. The method of claim 12, wherein the second threshold value is the same as the number of credentials.

14. The method of claim 8, further comprising:
capturing, via use of the vision system, a second captured data after at least the unlocking of the access device; and
generating an alert at least in response to an inability to identify, from the second captured data, an identity of one or more individuals that passes through the access point between the unlocking of the access device and before a subsequent locking of the access device.

15. The method of claim 8, further comprising:
capturing, via use of the vision system, a second captured data after at least the unlocking of the access device;
identifying, using the second captured data, an identity of one or more individuals that passes through the access point between the unlocking of the access device and before a subsequent locking of the access device; and
determining an authorization status for the identified one or more individuals, the authorization status corresponding to an authorization for the unlocking of the access device.

16. A method for detecting unauthorized entry attempts, the method comprising:
identifying, via use of a credential device, one or more credentials for one or more individuals;
unlocking, based on an authorization status associated with at least one credential of the one or more credentials, an access device for an access point corresponding to the credential device;
capturing, using a vision system, a first data corresponding to the access point, the first data being captured at least after the unlocking of the access device and before a subsequent locking of the access device;
determining, using the first data, a first count of one or more individuals that passed through the access point; and
generating an alert in response to the first count not satisfying a first threshold value.

17. The method of claim 16, further comprising comparing the first count to the first threshold value.

18. The method of claim 16, further comprising determining a number of the one or more credentials identified via use of the credential device, and wherein the first threshold value corresponds to the number of the one or more credentials.

19. The method of claim 16, wherein the first threshold value corresponds to a number of the one or more credentials having authorization for the unlocking of the access device.

20. The method of claim 16, further comprising:
determining a number of the one or more credentials identified via use of the credential device;
detecting, using a second information captured by the vision system, a second count of individuals around at least one of the credential device or access point; and
preventing the unlocking of the access device in response to a determination that the number of the one or more credentials does not satisfy the second count.
